(19) United States
(12) Patent Application Publication
(10) Pub. No.: US 2008/0208605 A1
(43) Pub. Date: Aug. 28, 2008

(54) SYSTEMS AND METHODS FOR RESPONDING TO THE OCCURRENCE OF AN EVENT

(75) Inventors: Amitabh Sinha, San Jose, CA (US); Andrey Kovalenko, Union City, CA (US); Dashiel Pare-Mayer, Fort Lauderdale, FL (US); Navaneetha Subramanian, Sunnyvale, CA (US); Shiva Madishetti, Santa Clara, CA (US)

Correspondence Address: CHOATE, HALL & STEWART / CITRIX SYSTEMS, INC., TWO INTERNATIONAL PLACE, BOSTON, MA, 02110, US

(73) Assignee: Citrix Systems, Inc., Fort Lauderdale, FL (US)

(21) Appl. No.: 11/875,883

(22) Filed: Oct. 20, 2007

Related U.S. Application Data
(60) Provisional application No. 60/862,365, filed on Oct. 20, 2006.

(51) Int. Cl. G06Q 99/00

(52) U.S. Cl. 705/1

(57) ABSTRACT

The system and method provide a business continuity application to a portion of a displaced workforce of an organization when an event occurs. The business continuity application, executing on a server within a data center, is used to define a response scenario to the occurrence of an event. The business continuity application allows for notifications to be sent to the workforce using a notification service that interfaces with the server, and further provides remote-access to computing resources via a remote access server that interfaces with the server. A communication gateway installed between the server and a private branch exchange further provides a portion of the business continuity application. Displays of portions of the business continuity application after the occurrence of an event are sent to end-users that can access the computing device. The computing device is further in communication with a portable memory device.

This application claims priority to U.S. Provisional Patent Application No. 60/862,365, entitled “Systems and Methods for Providing a Business Continuity Service,” filed Oct. 20, 2006. The entire contents of the aforementioned application are hereby incorporated by reference.

### FIELD OF THE INVENTION

The present application relates to business applications. In particular, the present application relates to systems and methods for providing a business application that provides business continuity for a workforce.

### BACKGROUND OF THE INVENTION

Some business continuity applications include applications that provide methods and systems for contacting large groups of people at pre-determined, and emergency phone numbers. Other business continuity applications allow displaced workforces to congregate in a single virtual location, and communicate with each other at this location. These continuity applications are provided in part to deal with a dispersed workforce, and in part to deal with, at times, emergency situations. Many business continuity applications provide a method for facilitating communication amongst a workforce.

### SUMMARY OF THE INVENTION

In one aspect, a method of providing a business continuity application to a portion of a displaced workforce, is shown and described. The workforce is a workforce in an organization, and the business continuity application is provided in response to the occurrence of an event. The method includes providing a server computing device that is located in a data center. Executing on the server is at least a portion of the business continuity application, which further includes an application for defining a response scenario to the occurrence of the event. A notification service is interfaced with the server computing device, and is further used to issue notifications to at least a portion of the workforce in response to the occurrence of an event. A remote access service is interfaced with the server, and the remote access service is further used to provide access to computing resources associated with the workforce during the occurrence of the event. A communications gateway is interfaced to both a private branch exchange of the workforce and to the server computing device. The communications gateway further provides at least a portion of the business continuity application. A display of a portion of the business continuity application is displayed to an end-user of a computing device after the occurrence of the event. The computing device is in communication with portions of the business continuity application.

In another embodiment, the method further includes providing a business continuity application via an application streaming service or application.

Still another embodiment includes providing a business continuity application via a remote display protocol.

One embodiment includes providing the business continuity as a service.

An embodiment can include issuing a notification to at least a portion of the workforce further by placing a call to a number designated by a caller so that communications can be established between a first endpoint and a second endpoint. This embodiment further includes receiving feedback information indicative of the failure to establish communication between the first endpoint and the second endpoint, and then redirecting the call to a portion of the notification service. Contact information associated with the caller designated number and indicative of a third endpoint is retrieved from a storage element. A call is then placed to the retrieved contact information to establish communication between the first endpoint and the third endpoint. In another embodiment, the placing a call to a second endpoint includes placing a call to a member of the workforce. Another embodiment includes retrieving contact information that includes an emergency number associated with the member of the workforce. The emergency contact information, in one embodiment, includes an email address associated with the member of the workforce. Other embodiments include placing a call to the retrieved contact information using one of either of the private branch exchange and a public switched telephone network. Still other embodiments include placing a call to the retrieved contact information using a virtual private network.

In one embodiment, providing access to communication resources includes providing access to information on a client machine using a remote display protocol.

Another embodiment includes displaying portions of a business continuity application that includes displaying a graphical user interface representative of a status of the occurrence of the event.

In one embodiment, displaying portions of a business continuity application further comprises displaying a graphical user interface representative of a directory service that accesses information of the workforce.

Other embodiments include displaying portions of a business continuity application, where a graphical user interface is displayed that establishes and interacts with an audio communications session.

Embodiments can further include displaying portions of a business continuity application, where a graphical user interface that establishes and interacts with an instant messaging system, is displayed.

In one embodiment, interfacing with a communications gateway further includes interfacing with a workforce gateway within a workforce continuity system.

Still other embodiments include interfacing with a workforce gateway that further includes establishing a connection via a network installed between the computing machine and the private branch exchange.

In another aspect, a graphical user interface that is displayed on a computing device and that provides continuity to an employee of a workforce, is shown and described. The graphical user interface is created by a program stored on a portable memory device, and is created in response to the occurrence of an event. A first portion is included in the graphical user interface, where the first portion displays information related to the status of an event or the occurrence of an event. The first portion further displays information using a first program stored on a portable device associated with an employee of the workforce. A second portion is included within the graphical user interface. This second portion displays a plurality of business tools available to the employee, each business tool being represented as icon and associated with a computing device providing the respective business tool. A third portion is included within the graphical interface that provides a directory service to the employee. The directory service is further associated with directory information of the workforce. A fourth portion is included within the graphical interface, where this fourth portion displays a list of at least a portion of the employees of the work force and a status related to each of the employees listed. A mechanism is further provided in the fourth portion that establishes at least one of an audio communications session and an instant messaging session.

In one embodiment, the portable memory device is a universal serial bus device. Other embodiments include a universal serial bus device that further includes a first reported volume that is configured to store data. In this embodiment the stored data includes the program stored on the universal serial bus. Further included in this embodiment is a second volume that is configured to store a bootstrap loader application. In this embodiment, the bootstrap loader application is further configured to update and execute the stored program.

In one embodiment, the business tools include a remote access application that provides remote access to a server that is in communication with the computing device.

In another embodiment, the business tools include a remote access application that provides remote access to a second computing device that is in communication with the computing device.

Still other embodiments include a =directory service that is in further communication with a storage element that is configured to store the contact information of workforce members.

### BRIEF DESCRIPTION OF THE DRAWINGS

The following figures depict illustrative embodiments of the method and system described herein. These figures are intended to illustrate and not limit the method and system described herein.

FIG. 1A is a block diagram of an embodiment of a network environment for a deployment of a business continuity and workforce displacement system.

FIG. 1B is a block diagram of an embodiment of a data center environment for a deployment of a business continuity and workforce displacement system.

FIG. 1C is a flowchart of an embodiment of a method for redirecting voice information during an occurrence.

FIGS. 1D and 1E are block diagrams of embodiments of a computing device.

FIG. 2A is a flowchart of an embodiment of an emergency communication forwarding scenario using insertion of a business continuity service in a coverage path.

FIG. 2B is a flowchart of an embodiment of an emergency communication forwarding scenario.

FIG. 2C is a block diagram of an embodiment of a system to implement a click-to-call communication.

FIG. 2D is a block diagram of an embodiment of a system to handle outbound communications.

FIG. 3A is a pictorial diagram representing an embodiment of a Universal Serial Bus (USB) device for providing software and services related to business and workforce continuity.

FIG. 3B is a flow diagram depicted an embodiment of a method for setting up and provisioning a USB device.

FIG. 3C is a flow diagram depicted an embodiment of a method for using a USB device.

FIG. 4A is a pictorial diagram representing an embodiment of the type of users of the business and workforce continuity solution described herein.

FIG. 4B is a pictorial diagram representing an embodiment of a user workflow architecture.

FIG. 4C is a pictorial diagram representing an embodiment of a user interface for creating an emergency scenario.

FIG. 4D is a pictorial diagram representing an embodiment of a user interface for a manager to approve an emergency scenario.

FIG. 4E is a pictorial diagram representing an embodiment of a USB device or stick for a user to use in case of emergency.

FIG. 4F is a pictorial diagram representing an embodiment of a user interface for testing an emergency scenario.

FIG. 4G is a pictorial diagram representing an embodiment of a user interface for activating an emergency.

FIG. 4H is a pictorial diagram representing an embodiment of a user interface for notification of an employee or user.

FIG. 4I is a pictorial diagram representing an embodiment of a user interface providing an employee communication center.

FIG. 4J is a pictorial diagram representing an embodiment of a user interface providing information for a roll call.

FIG. 4K is a pictorial diagram representing an embodiment of a user interface providing an employee workplace.

FIG. 4L is a pictorial diagram representing an embodiment of a user interface allowing users to collaborate for resources.

FIG. 4M is a pictorial diagram representing an embodiment of a user interface allowing users to communicate with peers.

FIG. 4N is a pictorial diagram representing an embodiment of a user interface allowing users to access a computing environment providing access to applications and data.

FIG. 5A is a pictorial diagram representing embodiments of user interfaces for the user's side bar.

FIG. 5B is a pictorial diagram representing other embodiments of user interfaces for the user's side bar.

FIG. 5C is a pictorial diagram representing other embodiments of user interfaces for the user's side bar.

FIG. 6A is a pictorial diagram representing embodiments of user interfaces for startup screens for the USB device.

FIG. 6B is a pictorial diagram representing other embodiments of user interfaces for startup screens for the USB device.

FIG. 6C is a pictorial diagram representing additional embodiments of user interfaces for startup screens for the USB device.

FIG. 7 is a flowchart of an embodiment of a method of providing a business continuity application.

### DETAILED DESCRIPTION OF THE DRAWINGS

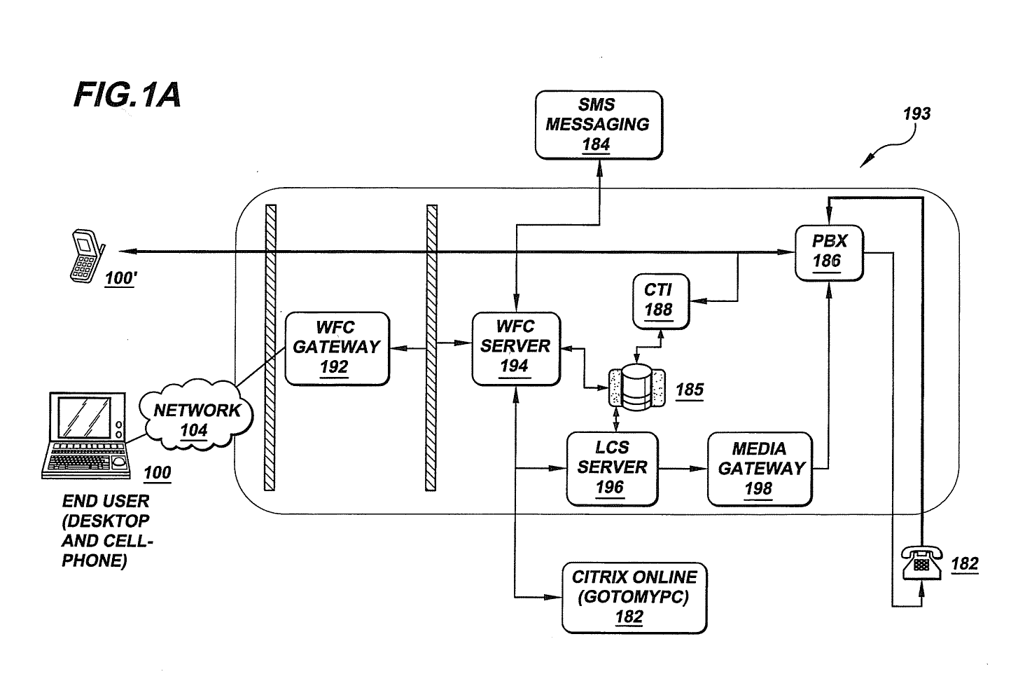

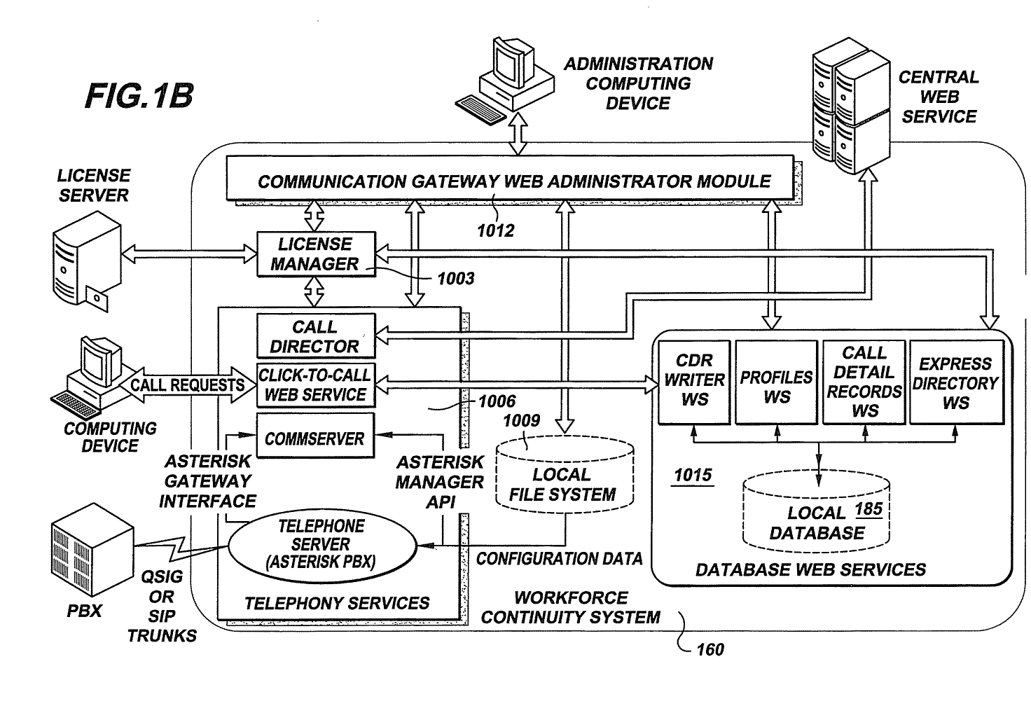

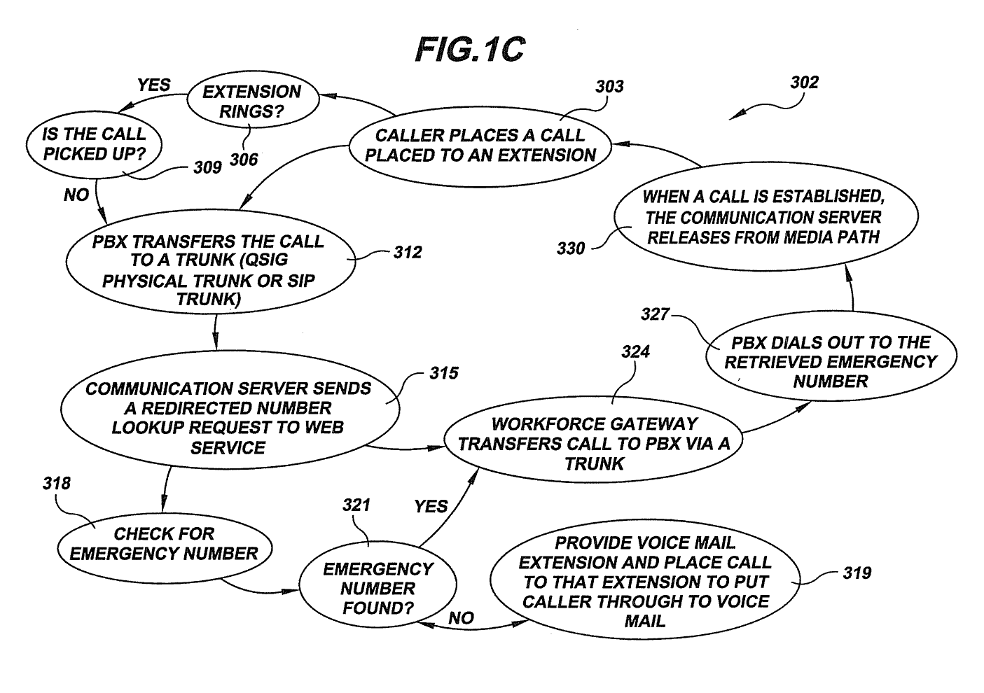

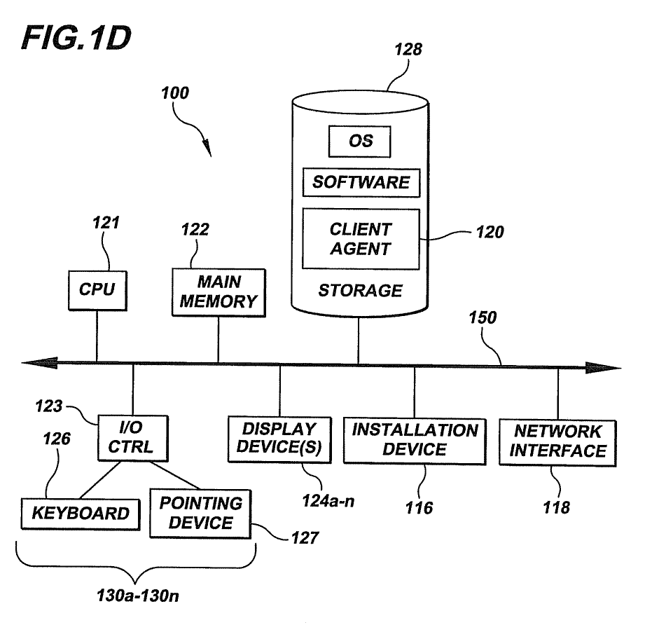

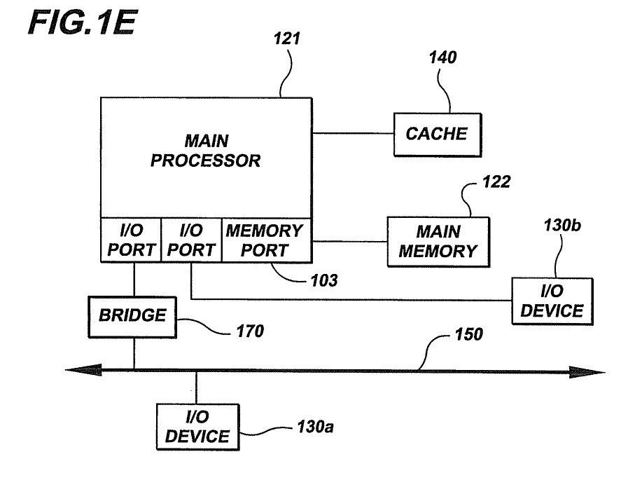

Illustrated in FIG. 1A is an embodiment of a system 193 for providing business and workforce continuity services and methods. Included within this system is a computing device 100 that communicates with a workforce continuity (WFC) server 194 via a network 104, and a WFC gateway 192. Also included is a telecommunications device 100′ in communication with a public branch exchange (PBX) 186, where the PBX 186 is further in communication with a second communication device 182. A short messaging service (SMS) or short messaging system 184 is included as are the following system components: a computer telephone integration device or software (CTI) 188; a remote access and computer remote control software or service 183; a communication server (LCS server) 196; one or more databases 185; and a media gateway 198.

Further referring to FIG. 1A in more detail, in one embodiment of the system 193, a computing device 100 is included. Embodiments of the computing device 100, can be any of the below described embodiments of a computing device 100. Other embodiments of the system 193 include a telecommunications device 100′ that is a cell-phone. Still other embodiments of the telecommunications device 100′ include a telecommunications device 100′ that can be any one of the following devices: a handheld computing machine; a computing device that includes the Microsoft Office Communicator;

In another embodiment of the system 193, a network 104 can include any one of the following networks: a local area network; a wide area network; a point to point network; a broadcast network; a telecommunications network; a data communication network; a computer network; an ATM (Asynchronous Transfer Mode) network; a SONET (Synchronous Optical Network) network; a SDH (Synchronous Digital Hierarchy) network; a wireless network; a wireline network; or any other network able to accomplish the systems and methods described herein. Still other embodiments include a network 104 that can be any of the networks described herein.

The workforce continuity gateway (WFC gateway) 192, in some embodiments of the system 193, provides access to the workforce continuity server (WFC server) 194. In one embodiment of the system 193, the WFC gateway 192 includes any type and form of gateway, device, appliance or interface unit able to provide access to the WFC server 194. Another embodiment of the system 193 includes a WFC gateway 192 that provides any one of the following connections to the computing device 100: a virtual private network (VPN) connection; a Secure Socket Layer (SSL) VPN; an IPsec based VPN connection; or any other connection that can be established over the network 104. Still other embodiments of the system 193 include a WFC gateway 192 that provides any of the following service, functionalities, or services: SSL VPN connectivity; switching/load balancing; Domain Name Service resolution; acceleration and an application firewall for communications between one or more clients and one or more servers; compression acceleration; decompression acceleration; Transmission Control Protocol pooling; Transmission Control Protocol multiplexing; Transmission Control Protocol buffering; caching; LAN acceleration; or WAN acceleration. In one embodiment of the system 193, the WFC gateway 192 comprises any of the following: gateways or appliances manufactured by Citrix Systems, Inc.; a Citrix Access Gateway, Standard Edition; a Citrix Access Gateway Advanced Edition; a Citrix Access Gateway Enterprise Edition; a Citrix Application Firewall functionality or device; a Citrix NETscaler appliance; or a Citrix WANscaler appliance.

The WFC server 194 comprises any type of server, appliance, or computing device for providing any portion of the services, functionality, operation, logic and/or integration of the business and workforce continuity services and functionality described herein. In one embodiment, the WFC server 194 can include any of the following: a web server; an HTTP (HyperText Transfer Protocol) server; a device that provides a web based user interface for accessing the functionality and operations of the services described herein; a portal web-site or service; one or more applications, programs, libraries, services, processes, tasks or set of executable instructions providing the logic, functionality and operations of the business and workforce continuity services described herein; or any type of workflow or logic engine for handling operations of the system. Another embodiment includes a WFC server 194 that includes any type and form of application delivery system. In this embodiment, the application delivery system can include any portion of the Citrix Access Suite™ by Citrix Systems, Inc., such as the MetaFrame or Citrix Presentation Server™ and/or any of the Microsoft® Windows Terminal Services manufactured by the Microsoft Corporation. In one embodiment, the WFC server 194 may deliver one or more applications to one or more users via a remote-display protocol or other protocol that enables remote-based or server-based computing. In another embodiment, the WFC server 194 may deliver one or more applications to clients or users via streaming of the application.

In one embodiment, the WFC gateway 192 and/or WFC server 194 includes a policy engine for controlling and managing the access to, selection of application execution methods and the delivery of applications. In some embodiments, the policy engine determines the one or more applications a user or client may access. In another embodiment, the policy engine determines how the application should be delivered to the user or client, e.g., the method of execution. In some embodiments, the application delivery system provides a plurality of delivery techniques from which to select a method of application execution, such as a server-based computing, streaming or delivering the application locally to a client for local execution.

In embodiment, the WFC server 194 may interface, comprise or otherwise use one or more databases 185 to store configuration, data or information. Embodiments can include a database 185 that is any of the following database types or forms: an SQL Server manufactured by the Microsoft Corporation; an Access Database manufactured by Microsoft Corporation; an Oracle database manufactured by Oracle Corporation; an object database; a database that includes a file system or one or more files; or other database type or form able to interface with the WFC server 194. Other embodiments include a database 185 that stores information or data identifying contact information and methods of communication for one or more users of the workforce continuity server 194. Still other embodiments utilize a file or other data item that interfaces with the WFC server 194 and stores information.

Embodiments can include a communication server 196 that provides one or more types of communication services via email, SMS, instant messaging (IM), Voice over Internet Protocol (VoIP) or any other form of telecommunications and communication mediums and means. In one embodiment, the communication server 196 comprises Live Communications Server manufactured by the Microsoft Corporation. In this embodiment, the communication server 196 provides tools necessary to connect users to public instant messaging (IM) Internet service providers, such as MSN, AOL, and Yahoo!. Using Microsoft Office Communicator, the Live Communications Server enabled users who are licensed for public IM connectivity, can add contacts, send instant messages, and share presence information with users of MSN Messenger, AOL Instant Messenger (AIM) and Yahoo! Messenger. In one embodiment, the computing device 100 or telecommunication device 100′ comprises the Microsoft Office Communicator. Further embodiments include a communication server 196 that provides any of the following services and capabilities: searching for contacts easily using an Address Book Service; integrating with Microsoft Office Outlook and Microsoft Exchange Server to let users view other contacts' free/busy information from their schedule, as well as display their ‘Out of Office’ messages directly in Microsoft Office Communicator; extending presence, including the ability to allow users to set ‘custom notes’, to provide more rich information to other contacts, enabling them to make more informed decisions on how to interact; and controlling enterprise phones directly from a computing device 100. With the appropriate private branch exchange (PBX) or public switched telephone network (PSTN) gateway infrastructure in place, Microsoft Office Communicator provides integration with enterprise telephony systems, allowing the user to initiate calls and even divert calls to a remote location when they are not at their desk. In other embodiments, the communication server 196 can initiate conference calls with partner service providers directly from Microsoft Office Communicator.

The media gateway 198 includes any type and form of server, gateway, device or appliance for communicating, translating or interfacing between disparate telecommunications networks. In one embodiment, a media gateway provides an interface between a first type of telecommunication network and a second type of telecommunication network. In another embodiment, a media gateway provides an interface between a first type of telecommunication protocol and a second type of telecommunication. In some embodiments, the media gateway converts between the different transmission and coding techniques of the telecommunication networks. In one embodiment, the media gateway includes a Voice over Internet Protocol (VoIP) media gateway. In some embodiments, the media gateway performs the conversion between Time Division Multiplexing (TDM) voice to VoIP. In yet another embodiment, the media gateway includes a signaling gateway. In some embodiments, a Signaling Gateway is a network component for translating signaling messages (e.g.,. information about call establishment and teardown) between one medium (e.g., Internet Protocol and another (PSTN). For example, a signaling gateway might translate between ISUP (ISDN User Part) and Session Initiation Protocol (SIP). In one embodiment, the media gateway may include a SMS gateway.

In one embodiment, the gateway 192, WFC server 196 or media gateway provides or supports the provision of IP telephony services and applications to a telecommunication device 100. In some embodiments, the gateway 200 includes Voice Office Applications having a set of one or more telephony applications. In one embodiment, the Voice Office Applications include the Citrix Voice Office Application suite of telephony applications. The gateway 192, WFC server 196 or media gateway may trans-code, transform or otherwise process user interface content to display in the form factor of the display of the telecommunication device 100.

The computer telephony integration (CTI) 188 includes software, hardware or any combination of software and hardware that provides a link between telephone systems and computers to facilitate incoming and outgoing call handling and control. In one embodiment, the CTI includes a physical link between a telephone and server. In some embodiments, CTI is a technique by which computers control telephony systems such as PBXs, for example, a call center where calls are queued up and routed to agents based on criteria such as caller ID and called number.

The PBX 186 can include any type and form of private branch exchange. In some embodiments, a PBX 186 includes a private voice-communications-capable switching facility located in a entity's premises which provides on-premises connection between terminals connected to it, including dial service, and may provide connections to between those terminals and other communications networks, including a PSTN. Other embodiments include a business workforce continuity management system the works with any of the following types of PBX system: any model and/or type of PBX system manufactured by Avaya, Cisco, Nortel, MyTel, or Semmins; or any other type of PBX system that includes voice mail.

The telephone 182 may include any type and form of telecommunication device. The telephone 182 can include any of the following: a phone including both software and hardware; an analog phone; a digital telephone; a voice-over-IP (VoIP) device for communicating voice data over internet protocol communications; a Cisco IP Phone manufactured by Cisco Systems, Inc; a Nortel IP Phone manufactured by Nortel Networks; any of the family of Avaya IP Phones manufactured by Avaya, Inc.; a phone that can support any type and form of protocol, including any real-time data protocol, Session Initiation Protocol (SIP), or any protocol related to IP telephony signaling or the transmission of media, such as voice, audio or data via a network 104; a phone that includes any type and form of user interface in the support of delivering media, such as video, audio and data; or any other phone that can implement the methods and systems described herein.

In one embodiment, the application delivery system 183 can be any one of the following types of systems: GoToMyPC; Citrix Presentation Server; Citrix Desktop Server; Citrix Tarpon for application streaming; or any other system able to deliver remote applications to a client machine.

The SMS Messaging 184 includes software, hardware or any combination of software and hardware for transmitting and/or receiving Short Message Service messages. In one embodiment, the SMS messaging 184 includes a service, gateway or interface for communicating SMS messages from one type of telecommunication form or network to a device capable of sending and/or receiving SMS. In some embodiments, the SMS messaging may be deployed on any type and form of device, gateway, server or appliance, including the WFC server 194, WFC gateway or Media gateway 198.

In one embodiment, the system may include multiple, logically-grouped servers In these embodiments, the logical group of servers may be referred to as a server farm. In some of these embodiments, the serves may be geographically dispersed. In some cases, a farm may be administered as a single entity. For example, any of the WFC gateway 192, WFC server 194, LCS server 196, database 185, and/or media gateway may be deployed as a server farm. In other embodiments, the server farm includes a plurality of server farms. In one embodiment, the server farm executes one or more applications on behalf of one or more clients. The servers within each farm can be heterogeneous. One or more of the servers can operate according to one type of operating system platform (i.e. Windows XP), while one or more of the other servers 106 can operate on according to another type of operating system platform (i.e., Unix or Linux). The servers of each farm do not need to be physically proximate to another server in the same farm 38. Thus, the group of servers logically grouped as a farm may be interconnected using a wide-area network (WAN) connection or medium-area network (MAN) connection. For example, a farm may include servers 106 physically located in different continents or different regions of a continent, country, state, city, campus, or room. Data transmission speeds between servers in the farm can be increased if the servers are connected using a local-area network (LAN) connection or some form of direct connection.

In one embodiment, any combination of an OpenSER, a STUN server, and a TURN server is used in lieu of the LCS server 196. A STUN server, in this embodiment, utilizes a STUN protocol that routes packets that transferred between devices installed behind a network address translation (NAT) firewall. The STUN (simple transversal of UDP through NATS) protocol can be installed on a computing machine to further create a STUN server that allows devices that communication over a network 104 to find their IP addresses, and further determine the type of NAT service a requesting device is sitting behind. STUN servers, in this embodiment, further accept STUN requests and return STUN responses. In this embodiment, OpenSER is a source SIP server that can provide any of the following services: load balancing; registrar; location server; proxy server; redirect server; or a VoIP application server. In this embodiment, OpenSER is used to provide VoIP for call redirection within the WFC system 160. A TURN (traversal using relay NAT) server is a computing machine configured to transfer data using the TURN protocol. The TURN protocol, in one embodiment, provides devices communicating via the network 104, to transmit and receive data over TCP or UDP connections. In this embodiment, the devices are located behind a NAT or firewall. The TURN server, in this embodiment, relays information between devices using the TURN protocol.

Although FIG. 1A shows a network 104 between the devices 100 and the gateway 192, the devices 100, 100′ and/or the WFC gateway 192 may be on the same network 104 or on different networks 104 and 104′. The networks 104, 104′ can be the same type of network or different types of networks. The network 104 and/or the network 104′ can be a local-area network (LAN), such as a company Intranet, a metropolitan area network (MAN), or a wide area network (WAN). In one embodiment, network 104′ may be a private network and network 104 may be a public network. In some embodiments, the main network 104 may be a private network and the sub-network 104′ a public network. In another embodiment, both the main network 104 and the sub-network 104′ are private networks. In some embodiments, clients 102 may be located at a branch office of a corporate enterprise communicating via a WAN connection over the network 104 to the servers 106 located at a corporate data center. In one embodiment, the network 104 and/or sub-network 104′ can be any type and/or form of network and may include any of the following: a point to point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network and a wire-line network. In some embodiments, the network 104 may include a wireless link, such as an infrared channel or satellite band. The topology of the network 104 and/or 104′ may be a bus, star, or ring network topology. The network 104 and/or 104′ and network topology may be of any such network or network topology as known to those ordinarily skilled in the art capable of supporting the operations described herein.

In one embodiment, the business workforce continuity system can be deployed as a Software-as-a-Service (SaaS) model. In this embodiment, any portion of the functionality, operation or logic of the business workforce continuity system can be provided via a hosted application model that is accessed by one or more users via a web-page or portal. When deploying the business workforce continuity system as a service, the software stack of the relational database management system, operating system and application are designed for multi-tenancy, meaning that the system can host more than one workforce members at the same time. The SaaS delivery model of the business workforce continuity system, in one embodiment, may provide any of the following services or abilities: ability to configuration notifications; ability to configure emergency scenarios; ability to configure work flows; ability to provide surveys, message boards, and status; ability to allow users to generate and add content to the business workforce continuity system; ability to dynamically identify types and locations of emergency resources; and further provide voice and remote-computer-access via applications such as GoToMyPC, an application distributed by Citrix Online. In other embodiments, the business workforce continuity system can be streamed from a server to a client and published within an isolation environment. Still other embodiments include providing the business workforce continuity system via any other application streaming system. In one embodiment, the business workforce continuity system can be provided via any of the following application delivery techniques offered by Citrix: Citrix NetScaler; Citrix Presentation Server; and Citrix Desktop Server.

Illustrated in FIG. 1B is an embodiment of a workforce continuity system 160 that includes a license manager 1003, a set of telephony services 1006, a local file system 1009, a communication gateway web administration module 1012, and database web services 1015. In communication with the workforce continuity system 160 is a license server, a computing machine operated by a user, a private branch exchange, an administrative computing machine, and the central web service.

Further referring to FIG. 1B, and in more detail. Those devices in communication with the workforce continuity management system 160, can in some embodiments, include additional devices such as: additional computing machines; additional administrative computing devices; or any other device required to provide business continuity to a workforce. The public branch exchange is, in this embodiment, used to receive workforce-member initiated calls, and further redirect calls to emergency numbers and alternative extensions. A user accesses the workforce continuity system via a computing device. In this embodiment, the computing device can be used to perform click-to-call requests. A license server is further used to route

In this embodiment, a license manager 1003 is included within the workforce continuity system 160. The license manager 1003, in this embodiment, communicates with the license server and performs checks with the license server to control individual features of the workforce continuity system 160. In some embodiments, the license manager 1003 can perform end-user authentication based on supplied domain user credentials. The license manager 1003, in this embodiment, issues handles to the requests issued from authenticated end-users.

In one embodiment, the workforce continuity system 160 includes a group of telephone services 1006 that include: a call director; a click-to-call web service; a communications server; a telephony server; an asterisk gateway interface installed between the telephony server and the communications server; and an asterisk manager installed between the telephony server and the communications server. The click-to-call web service is a service that provides authentication of the click-to-call requests received by the workforce continuity system 160 and further retrieves an end-user's extension or a an emergency number using directory information stored within a storage element included in the workforce continuity system 160. Other embodiments include a click-to-call service that uses a token or login credential to authenticate the end-user, or a license handle that is supplied with the request and that performs the authentication. A communications server is included within the telephony services 1006, and is used to interface with the telephony server, where the telephony server is used to integrate with different customer PBXs via one or more QSIG, or SIP trunks. In one embodiment, the telephony server is based on the ASTERISK PBX software distributed by Digium, Inc. Asterisk is a complete IP PBX in software, and runs on any of the following operating systems: Linux, Mac OS, OpenBSD, FreeBSD, and Sun Solaris, or any other operating system able to carry out the methods and systems described herein. Communication between the communications server and the telephony server is further enabled by an Asterisk Gateway Interface, and an Asterisk Manager, where both are provided by the Asterisk PBX software. In this embodiment, the Asterisk Gateway Interface provides communication capabilities to the telephony server and the comm. server, while the Asterisk Manager managers communication between the telephony server and the comm. server. In further embodiments, a communication server is provided to aid in forwarding all inbound calls received on the workforce member's PBX extension to a retrieved emergency number specified by the workforce member.

In one embodiment, a local file system 1009 is further included in the workforce continuity system 160. The file system 1009, in this embodiment, the file system 1009 organizes directories and files according to how they will be implemented in the disk operating system. File system types that may be used include: FAT16, FAT32, EAFS, NTFS, HPFS, S51K, Ext2, AFS. The file system can in some embodiments store configuration files, logs, profiles, directories, databases, or additional data. The local file system 1009, in one embodiment, communicates with the telephony services 1006 and further provides the telephony server within the telephony services 1006 with configuration data that can be utilized to configure the telephony server to interface with the communication server and to interface with the rest of the components included and in communication with the workforce continuity system 160.

Other embodiments include a database of web services 1015 that includes a local database, a CDR writer WS, profiles WS, call detail records WS, and an express directory WS. The express directory included in the database web services 1015 and in communication with the local database, provides the ability to traverse more than one directory without having to aggregate the directories. In one embodiment, the express directory receives an instructions from the telephony services 1006 to locate a portion of contact information that is stored in one or more directories. In response to receiving the command, the express directory initiates more than one directory handler routines. In this embodiment, more than one directory handler may be used to handle the each of the different contact information formats. Directory handlers traverse the directories within the local database and locate the requested contact information. When more than one directory contains the same contact information, the duplicate contact information is removed so that only one directory contains the contact information. Once retrieved, the contact information is returned to the requesting workforce continuity 160 device.

In one embodiment, a communication gateway web administration module 1012 is included. The administration module 1012 can, in this embodiment, communicates with the license manager 1003, the local file system 1009, the telephony services 1006, and the database web services 1015. The administration module 1012 can, in this embodiment, use the devices connected to the module 1012 to perform any of the following tasks: access the local file system 1009 and further retrieve, transmit and update files within the local file system 1009; configure features and aspects of the PBX using the telephony services 1006; provision the PBX and the workforce continuity system 160; configure user profiles and network settings using the license server, or access and manipulate the database web services 1015. The administration module 1012 is further connected to an administration computing device via either a direct or web-based interaction.

Illustrated in FIG. 1C, is a method 302 of redirecting a call using the BWC system 160. A call is first placed, by a caller, and to a caller-designated number (step 303). When the caller-designated number rings (step 306), and the call is not picked-up by a receiver (step 309); the PBX re-directs the call to a trunk (step 312). The communication server sends a re-directed number lookup request to the central web service (step 315), and a check is made for an emergency number (step 318), and if an emergency number is found (step 321), the workforce gateway transfers the call to the PBX via the trunk (step 324). When an emergency number is not found, a voice mail extension is provided and a call is placed to that extension so that the caller may be put through to voice mail (step 319). When an emergency number is found, and the workforce gateway transfers the call to the PBX via a trunk (step 324), the PBX then dials out the retrieved emergency number (step 327). When a call is established, the communication server then releases itself from the media path (step 330).

Referring to FIG. 1C in more detail, in one embodiment, a caller places a call to a caller-designated number (step 303). The caller designated number, in this embodiment, is an extension within the workforce private branch exchange 186. Other embodiments include a caller that places a call to a number via a public branch exchange, or an embodiment where the caller places a call to a number within a private branch exchange within a public branch exchange. In one embodiment, the method 302 includes placing a call to an extension which further causes a phone 182 to ring. Still further embodiments include placing a call to a toll free number that terminates on the workforce's PBX and then specifying the workforce member's extension after an IVR prompt.

Embodiments include a caller that can be a client, where a BWC system client can be any of the following: a member of the workforce; a computing machine enabled as a client when a member of the workforce creates a secure link between the computing machine and the BWC system 160; or any other computing device able to participate as a user within the BWC system 160. The client may include one or more client agents that can provide: end point detection and authorization; LAN and application delivery acceleration; WAN acceleration; remote display or server based computing processing; VPN and secure access gateway functionality; or application delivery. The client agent may include any of the client agents manufactured by Citrix Systems, Inc. including but not limited to, any of the client agents for the Access Gateway appliance, NETscaler appliance, Citrix Application Firewall, or WANscaler appliance. The client agent may also include an ICA client that supports the Independent Computing Architecture (ICA) protocol of Citrix Systems, Inc. and as used with the Citrix Presentation Server product embodiments. In another embodiment, the client agent may include any type and form of agent for supporting or providing streaming of one or more applications. Still other embodiments include client agents or software able to provide the following functionality: click-to-call; a SIP phone, an IP phone, or a VoIP phone; instant messaging and presence; BWC system 160 logic; and VPN logic. In some embodiments, any one or more, or all, of these functions or applications may be provided or delivered via a USB device or stick. In other embodiments, any one or more, or all, of these functions or applications may be provided or delivered via download from a web-site, such as a business continuity management (BCM) portal, or from a BCM appliance or WFC gateway. In another embodiment, an appliance, such as the BCM appliance or WFC gateway may automatically deliver the client-side applications or agent, and the computing device may automatically install and/or execute the applications.

In one embodiment, the extension rings (step 306), and the call is not “picked up” (step 309). Other embodiments include using the PBX to transfer the call to a trunk (step 312) upon placing a call to the caller-determined extension (step 303). Still other embodiments may include using the PBX to transfer the call to a trunk (step 312) once it is determined that the extension rings (step 306). In one other embodiment, when a determination is made that extension has not rung (step 306), the PBX transfers the call to a trunk (step 312). The trunk can be either a QSIG physical trunk, or a SIP trunk. The Communication server receives the inbound call setup and extracts the redirecting party's extension.

In one embodiment the communication server sends a re-directed number lookup request to the central web service (step 315). The central web service then interacts with the WFC system 160 to find an emergency number (step 318), and if the emergency phone number is found (step 321), the workforce gateway transfers the call to the PBX via the a trunk (step 324). If no emergency number is found, then an empty value is returned and a voice mail extension is provided so that a call may be placed to the voice mail extension to put the caller through to voice mail (step 319). In one embodiment, the method 302 includes searching for an emergency number that corresponds to the number called by the user. A corresponding number can be determined by using an identifier or flag that corresponds to the user-called number. The trunk to which the retrieved emergency number is sent, can be any of the trunks described herein.

Once the workforce gateway transfers the call to the PBX using the trunk (step 324), the PBX dials out to the retrieved emergency number (step 327). If a call is established, then the user may talk with the user without knowing that the call was forwarded, and the communication server further releases itself from the media path (step 330). If the call is not established, then in one embodiment, a voice mail extension may be provided and a call is placed to the voice mail extension so that the caller is redirected to a voice mail (step 330). In one embodiment, when the call is established, the communication server releases itself from the voice path established between the PBX and the workforce gateway. In an embodiment where a QSIG trunk is used, the communication server will release itself by issuing a path replacement additional network feature that causes the PBX to send a facility message on one of the call legs, which the communications server re-broadcasts to the other call leg. The PBX then sends an ISDN release to both call legs and bridges the talk path between the caller and the PBX user locally to remove the communication server from the signaling path. IN another embodiment where a SIP trunk is used, the communication server and the PBX server issue SIP invites to the outbound call legs advertising media ports of the incoming calls. In this embodiment, after the outgoing PBX call leg answers the call with a SIP OK response, the communication then sends a SIP re-invite to the incoming call leg and advertises the media port of the outbound call leg. Further, when this occurs in this embodiment, the resulting connection will include signaling legs that are controlled by the communication server for the duration of the call, but the call information will be sent between the two IP PBX ports, removing the communication server from the media path but not releasing the communication server entirely.

The servers, gateway, database, computer and telecommunication, software and services and any other item or method depicted in FIGS. 1A-1C may be deployed as and/or executed on any type and form of computing device, such as a computer, network device or appliance capable of communicating on any type and form of network and performing the operations described herein. FIGS. 1D and 1E depict block diagrams of a computing device 100. As shown in FIGS. 1D and 1E, each computing device 100 includes a central processing unit 101, and a main memory unit 122. As shown in FIG. 1D, a computing device 100 may include a visual display device 124, a keyboard 126 and/or a pointing device 127, such as a mouse. Each computing device 100 may also include additional optional elements, such as one or more input/output devices 130a-130b (generally referred to using reference numeral 130), and a cache memory 140 in communication with the central processing unit 101.

The central processing unit 101 is any logic circuitry that responds to and processes instructions fetched from the main memory unit 122. In many embodiments, the central processing unit is provided by a microprocessor unit, a single core processor, a dual core processor, or a processor with more than two cores. Other embodiments of the computing device 100 include a processor that is able to carry out the methods and systems described herein.

Main memory unit 122 may be one or more memory chips capable of storing data and allowing any storage location to be directly accessed by the microprocessor 101, such as Static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Enhanced DRAM (EDRAM), synchronous DRAM (SDRAM), JEDEC SRAM, PC100 SDRAM, Double Data Rate SDRAM (DDR SDRAM), Enhanced SDRAM (ESDRAM), SyncLink DRAM (SLDRAM), Direct Rambus DRAM (DRDRAM), or Ferroelectric RAM (FRAM). The main memory 122 may be based on any of the above described memory chips, or any other available memory chips capable of operating as described herein. In the embodiment shown in FIG. 1D, the processor 101 communicates with main memory 122 via a system bus 150 (described in more detail below). FIG. 1D depicts an embodiment of a computing device 100 in which the processor communicates directly with main memory 122 via a memory port 103. For example, in FIG. 1E the main memory 122 may be DRDRAM.

FIG. 1E depicts an embodiment in which the main processor 101 communicates directly with cache memory 140 via a secondary bus, sometimes referred to as a backside bus. In other embodiments, the main processor 101 communicates with cache memory 140 using the system bus 150. Cache memory 140 typically has a faster response time than main memory 122 and is typically provided by SRAM, BSRAM, or EDRAM. In the embodiment shown in FIG. 1D, the processor 101 communicates with various I/O devices 130 via a local system bus 150. Various busses may be used to connect the central processing unit 101 to any of the I/O devices 130, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 124, the processor 101 may use an Advanced Graphics Port (AGP) to communicate with the display 124. FIG. 1E depicts an embodiment of a computer 100 in which the main processor 101 communicates directly with I/O device 130 via HyperTransport, Rapid I/O, or InfiniBand. FIG. 1E also depicts an embodiment in which local busses and direct communication are mixed: the processor 101 communicates with I/O device 130 using a local interconnect bus while communicating with I/O device 130 directly.

The computing device 100 may support any suitable installation device 116, such as a floppy disk drive for receiving floppy disks such as 3.5-inch, 5.25-inch disks or ZIP disks, a CD-ROM drive, a CD-R/RW drive, a DVD-ROM drive, tape drives of various formats, USB device, hard-drive or any other device suitable for installing software and programs such as any business and workforce continuity software 120, or portion thereof. The computing device 100 may further comprise a storage device 128, such as one or more hard disk drives or redundant arrays of independent disks, for storing an operating system and other related software, and for storing application software programs such as any program related to the of business and workforce continuity software 120. Optionally, any of the installation devices 116 could also be used as the storage device 128. Additionally, the operating system and the software can be run from a bootable medium, for example, a bootable CD, such as KNOPPIX®, a bootable CD for GNU/Linux that is available as a GNU/Linux distribution from knoppix.net.

Furthermore, the computing device 100 may include a network interface 118 to interface to a Local Area Network (LAN), Wide Area Network (WAN) or the Internet through a variety of connections including, but not limited to, standard telephone lines, LAN or WAN links (e.g., 802.11, T1, T3, 56 kb, X.25), broadband connections (e.g., ISDN, Frame Relay, ATM), wireless connections, or some combination of any or all of the above. The network interface 118 may comprise a built-in network adapter, network interface card, PCMCIA network card, card bus network adapter, wireless network adapter, USB network adapter, modem or any other device suitable for interfacing the computing device 100 to any type of network capable of communication and performing the operations described herein.

A wide variety of I/O devices 130a-130n may be present in the computing device 100. Input devices include keyboards, mice, trackpads, trackballs, microphones, and drawing tablets. Output devices include video displays, speakers, inkjet printers, laser printers, and dye-sublimation printers. The I/O devices 130 may be controlled by an I/O controller 123 as shown in FIG. 1D. The I/O controller may control one or more I/O devices such as a keyboard 126 and a pointing device 127, e.g., a mouse or optical pen. Furthermore, an I/O device may also provide storage 128 and/or an installation medium 116 for the computing device 100. In still other embodiments, the computing device 100 may provide USB connections to receive handheld USB storage devices.

In some embodiments, the computing device 100 may comprise or be connected to multiple display devices 124a-124n, which each may be of the same or different type and/or form. As such, any of the I/O devices 130a-130n and/or the I/O controller 123 may comprise any type and/or form of suitable hardware, software, or combination of hardware and software to support, enable or provide for the connection and use of multiple display devices 124a-124n by the computing device 100. For example, the computing device 100 may include any type and/or form of video adapter, video card, driver, and/or library to interface, communicate, connect or otherwise use the display devices 124a-124n. In one embodiment, a video adapter may comprise multiple connectors to interface to multiple display devices 124a-124n. In other embodiments, the computing device 100 may include multiple video adapters, with each video adapter connected to one or more of the display devices 124a-124n. In some embodiments, any portion of the operating system of the computing device 100 may be configured for using multiple displays 124a-124n. In other embodiments, one or more of the display devices 124a-124n may be provided by one or more other computing devices, such as computing devices 100a and 100b connected to the computing device 100, for example, via a network. These embodiments may include any type of software designed and constructed to use another computer's display device as a second display device 124a for the computing device 100. One ordinarily skilled in the art will recognize and appreciate the various ways and embodiments that a computing device 100 may be configured to have multiple display devices 124a-124n.

In further embodiments, an I/O device 130 may be a bridge 170 between the system bus 150 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, or a Serial Attached small computer system interface bus.

A computing device 100 of the sort depicted in FIGS. 1D and 1E typically operate under the control of operating systems, which control scheduling of tasks and access to system resources. The computing device 100 can be running any operating system such as any of the versions of the Microsoft® Windows operating systems, the different releases of the Unix and Linux operating systems, any version of the Mac OS® for Macintosh computers, any embedded operating system, any real-time operating system, any open source operating system, any proprietary operating system, any operating systems for mobile computing devices, or any other operating system capable of running on the computing device and performing the operations described herein.

In other embodiments, the computing device 100 may have different processors, operating systems, and input devices consistent with the device. For example, in one embodiment the computer 100 is a Treo 180, 270, 1060, 600 or 650 smart phone manufactured by Palm, Inc. In this embodiment, the Treo smart phone is operated under the control of the PalmOS operating system and includes a stylus input device as well as a five-way navigator device. Moreover, the computing device 100 can be any workstation, desktop computer, laptop or notebook computer, server, handheld computer, mobile telephone, any other computer, or other form of computing or telecommunications device that is capable of communication and that has sufficient processor power and memory capacity to perform the operations described herein.

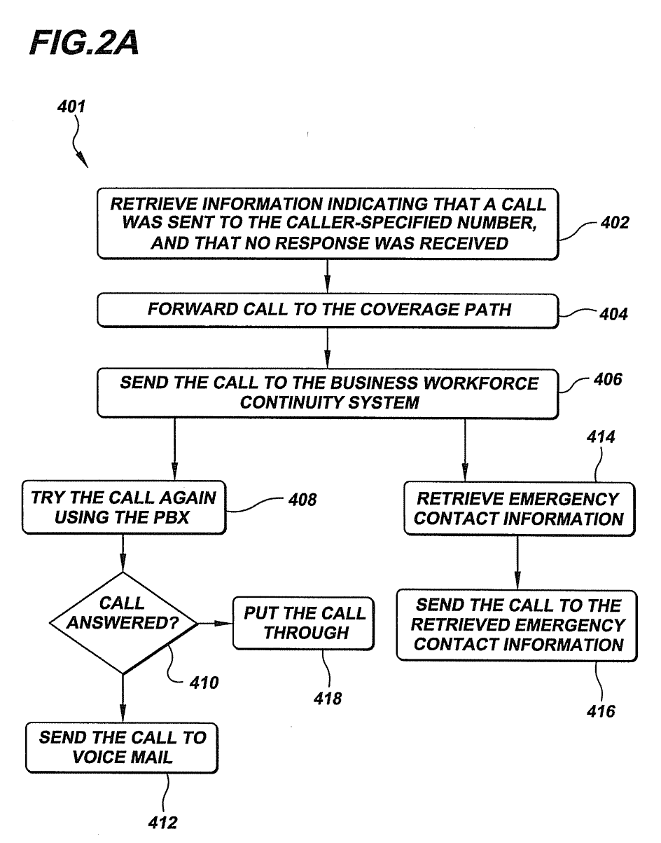

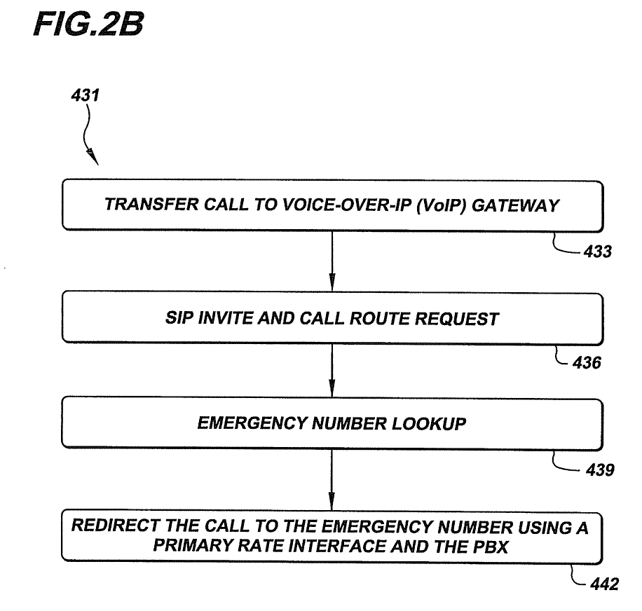

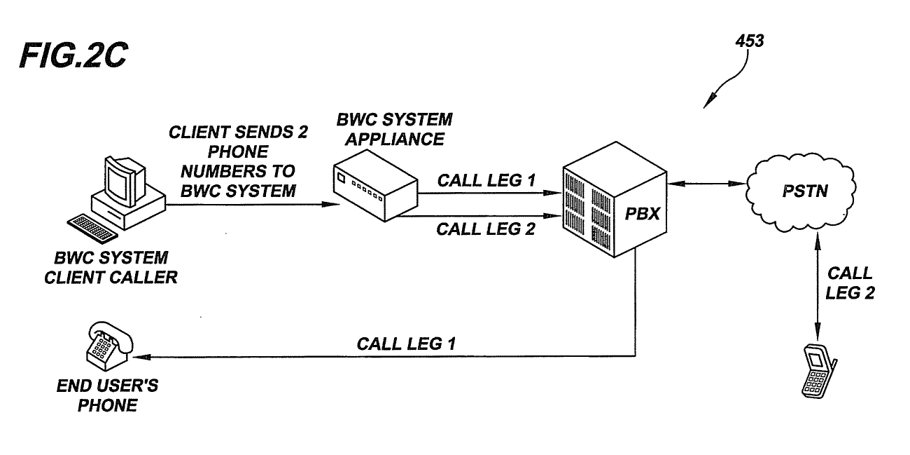

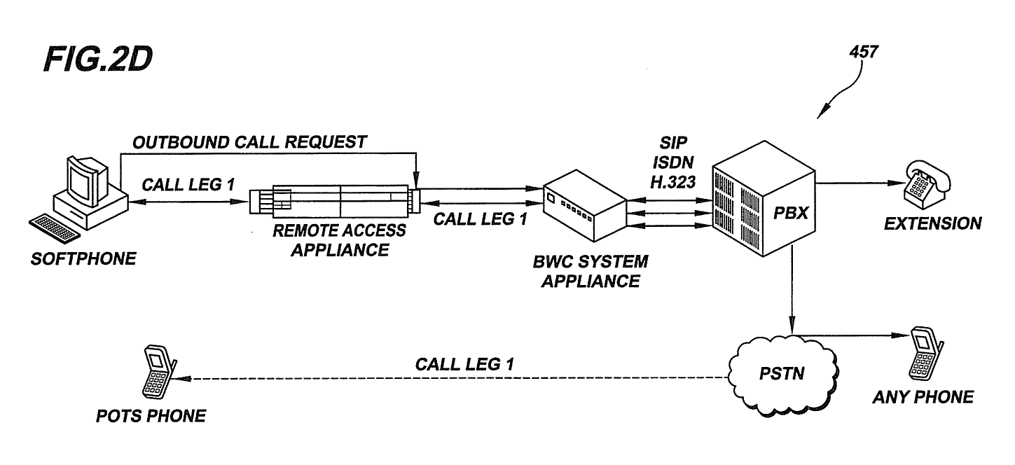

Illustrated in FIG. 2A is one embodiment of call forwarding during an emergency, where a call is forwarded using the BWC system 160. The method 401 includes receiving information indicative that the user called a caller-identified number and received no response (step 402). The original call is then forwarded to a coverage path (step 404), and can be further forwarded to the BWC system 160 (step 406). One branch of the method 401 tries calling the caller-specified number again (step 408), and making a determination as to whether or not an answer was received (step 410). If no answer is received, then the call is sent to voice mail (step 412), and if an answer is received, the call is put through (step 418). In another branch of the method 401, emergency contact information is retrieved from the database 185 or other storage element (step 414), and the call is re-directed to the retrieved emergency contact information (step 416).

Further referring to FIG. 2A in more detail, in one embodiment, information is received by the method 401 indicating whether or not a user was able to call the intended number or extension (step 402). The received information can be feedback data in the form of an alert sent to the method 401, or in the form of a logic value indicative of whether or not the call was successful. In one embodiment, the information can indicate whether or not the caller was successful in reaching the intended recipient. In other embodiments, this information can detail the terms of parameters of the call including identification information corresponding to the intended call-recipient, the number called, and identification information corresponding to the caller.

In one embodiment of the method 401, the call is forwarded to a coverage path (step 404). The coverage path can be included in the PBX 186, and can be configured, modified, defined, designed and constructed to transfer the call to the BWC system 160. Other embodiments include a coverage path that signals the PBX to redirect extensions called, to TDM lines without user intervention. In this embodiment, and during an emergency situation, if a system user is displaced and a call to that user is not completed, the call can be substantially automatically redirected from the PBX system 186 to emergency contact information. Other embodiments include a coverage path that transfers the call to an external number or service. Still other embodiments may provide a media gateway to translate or interface the call from one type of telecommunication network or protocol to another network or protocol. In other embodiments, the coverage path is adapted to transfer the call to a BWC system appliance or server, such as the WFC gateway or WFC server as depicted in FIG. 1A.

The call is redirected to the BWC system 160 (step 406), in one embodiment, where the call is further sent along one of two branches within the method 401. In one embodiment, the call can be attempted again (step 408), and a determination is made as to whether or not the call was answered (step 410). If the call was not answered, then the call is forwarded to voice-mail (step 412), and if the call is answered, the call is put through (step 418). Other embodiments of the method 401 may search for and retrieve emergency contact information when the call is not answered. Still other embodiments may in addition to sending the call to voice-mail (step 412), send the call to retrieved emergency contact information (step 416). In one embodiment, the call may not be attempted again, and rather emergency contact information will be retrieved (step 414), and the call will be forwarded to retrieved emergency contact information (step 416).

In one embodiment, emergency contact information is retrieved (step 414), and the call is re-directed according to the retrieved emergency contact information (step 416). This emergency contact information can include any one of the following: an emergency extension; an emergency phone-number; an emergency email address; or any other emergency address or location identifier that allows a call to be re-directed to a caller during an emergency. Still further embodiments include emergency information that is stored in the database 185 or in another storage element within the BWC system 160. Transfer of the call using emergency information can, in some embodiments, cause the call to be re-directed to any of the following devices: a computing device; an electronic voice-mail; a server; a VoIP phone; a cell-phone; an analog phone; or any other computing device or telecommunications device. The BWC system 160 may deploy any type and form of system or use a service that determines the most effective or appropriate emergency contact number for contacting a user. In some embodiments, a service is used that verifies or confirms the current status of an ordered list of emergency contact info to determine at which number or telecommunication location, a user can be reached. In one embodiment, a service is used that determines the status of the emergency contact numbers. This embodiment of a service can further determine to which emergency contact number the call should be redirected during an emergency. For example, upon the coverage path transferring to the BWC system 160, the BWC system 160 may use a service or other method to check the status of stored contact numbers. The BWC system 160 then determines, in this embodiment, the last emergency contact number used to contact or reach a user, and attempts to redirect the call to this user. Still other embodiments include a BWC system 160 that attempts to transfer the call to one or more than one emergency contact numbers stored in the BWC system 160 and associated with a particular user.

In still other embodiments, if the BWC system 160 is unable to transfer the call to a contact number of the user, then the BWC system 160 may transfer the call back to the coverage path of the PBX. In some embodiments, the PBX will continue re-directing the call to the next point in the coverage path. For example, the PBX may then transfer the call to voice mail. In another embodiment, if the BWC system 160 cannot transfer the call to a contact number of the user, the BWC system 160 may terminate or drop the call. In some embodiments, the BWC system 160 may accept the call and provide a voice mail service for the user. In yet another embodiment, the BWC system 160 may transmit or forward the voice mail message to the user upon obtaining a working contact number or determining a contact number in which to reach the user.

In one embodiment of the system 401 (not illustrated), the BWC system 160 can provide a medium through which calls can be forwarded using a public switched telephone network (PSTN), or from a PSTN to a session initiation protocol (SIP) endpoint. In this embodiment, the BWC system 160 forwards or transfers the call to a soft-phone or IP phone, and acts like a PSTN for a SIP gateway. In some embodiments, an appliance within the BWC system 160, transfers or translates the call to the soft-phone using a VPN appliance. The BWC system 160 can, in some embodiments, be deployed in the form of an appliance.

The method 401 can be further described as a method for implementing at least a part of a notification service, where the data center can act in part as a server that executes the BWC system application. In this embodiment, the method 401 is used to notify workforce members of an emergency event, or to notify workforce members of business related events and/or protocols during a system-designated emergency situation.

Illustrated in FIG. 2B is one embodiment of a method 431 for redirecting a call generated by a caller using a private branch exchange 186 and determining that there is no response to the generated call. When feedback data indicates that the PBX extension rung did not answer, the call is transferred to a voice-over-IP (VoIP) gateway via a primary rate interface (step 433). The VoIP gateway receives the transferred call, and transmits a SIP invite—call route request to a SIP redirect proxy (step 436). The SIP redirect proxy requests a number forwarding lookup from the BWC system 160 and responds with a SIP 302 moved command with the forwarding number to the VoIP gateway (step 439). The VoIP gateway then transfers, routes or translates the call from SIP to the PBX to re-direct the call to a forwarding number associated with the user (step 442). In some embodiments, when the user does not answer when the call is redirected to the forwarding number, the coverage path of the PBX may have the call transferred to a voice mail server. Redirection of the call to the forwarding number associated with the user is accomplished using a primary rate interface, the public branch exchange, and using a public switched telephone network.

In one embodiment of the method 431 depicted in FIG. 2B, when the call is redirected to the forwarding number associated with the user (step 442), the VoIP gateway can receive a SIP 302 move command indicating that the call should be redirected to a SIP telecommunication destination. This destination can, in some embodiments, be an email address. When the redirect command is received, the call is redirected to the destination using a IP based telecommunication session established by the VoIP gateway over a network. The established telecommunication session can, in some embodiments, be between the VoIP gateway and a soft-phone, IP phone, or other VoIP phone associated with the destination address. Once the telecommunication session is established, the call is further re-directed to the destination email address, or other destination endpoint. In other embodiments of the method 431, the VoIP gateway can establish a connection to a telephone using a second VoIP gateway that further provides a media gateway or interface via the public switched telephone network to a phone or other telecommunications device.

FIG. 2C depicts an embodiment of the BWC system 160 using a click-to-call implementation to initiate the telecommunication session. A BWC system 160 client intercepts the number to call (number clicked), and pairs this with the users preferred call back device (e.g., cell or local extension) and sends the two numbers to BWC system 160. BWC system 160 places both calls though the PBX and bridges the call once they are both connected. In other embodiments, the method 453 illustrated in FIG. 2C can be a method for implementing a notification service using click-to-call as described in FIG. 2B.

FIG. 2D depicts another embodiment for outbound calling that is similar to click-to-call in an emergency location. In this embodiment, a BWC system 160 client on computing device 100 initiates an outbound call request to the BWC system 160 appliance. The BWC system 160 appliance first dials user at the emergency location and the BWC system 160 appliance bridges the call to the outbound number with the user's phone. In other embodiments, the method 457 illustrated in FIG. 2D can be a method for implementing a notification service as described in FIG. 2B and FIG. 2C.

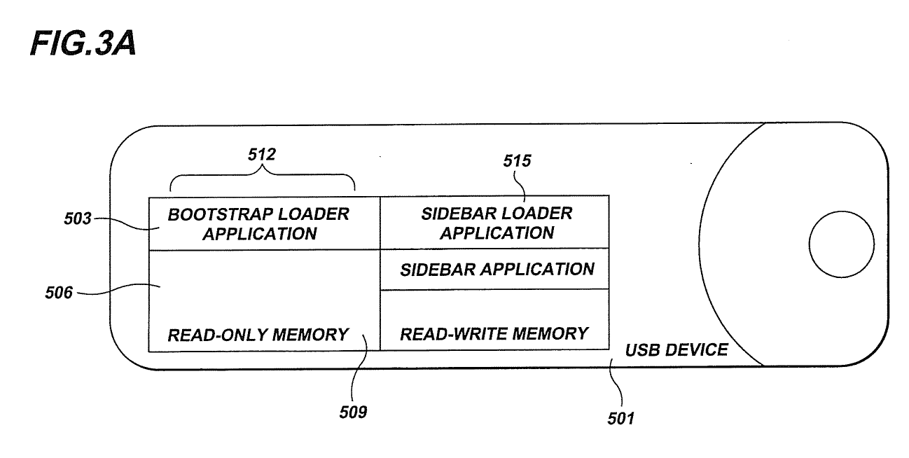

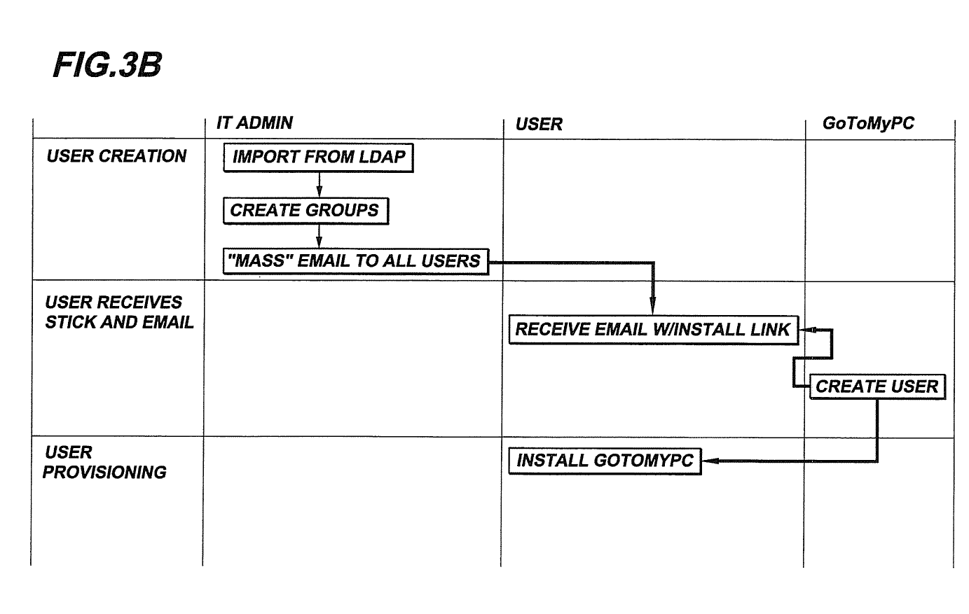

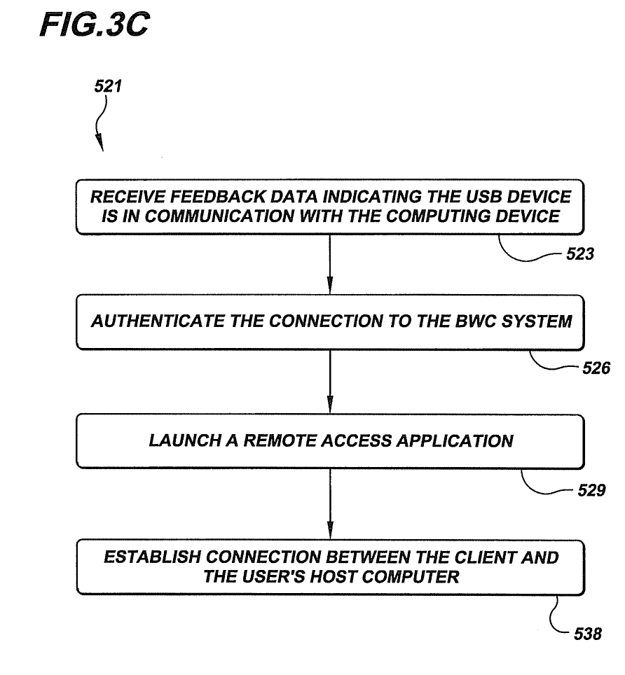

Illustrated in FIG. 3A is one embodiment of a USB device 501 or stick configured to deliver BWC system 160 client-side application content. Included within the USB stick 501 is memory 518 that is partitioned into a read-only memory partition 512, and a read-write memory partition 515. Installed on the read-only memory partition 512 is a bootstrap loader application 503; and installed on the read-write memory partition 515 is a sidebar loader application 506, and a sidebar application 509.

In one embodiment of the USB device 501, the device is a USB stick 501. Other embodiments could include any of the following memory devices in lieu of the USB stick 501: a flash drive; a compact disc; a floppy disk; a flash solid-state drive; or any other memory device able to be partitioned to include the above listed elements. Other embodiments include a USB stick 501 with memory 518 that is read-only memory. Another embodiment includes a USB stick 501 with memory 518 that is a read-write memory. In the embodiment shown in FIG. 3A, the read-write memory 515 can provide a secure storage element. Still other embodiments include a USB stick 501 that reports two volumes when placed in communication with a computing device. The first reported volume is, in this embodiment, a data partition that is the bulk of the device's storage. The second reported volume is, in this embodiment, a section of memory that emulates a CD ROM device. This second volume includes an executable file that is executed by the operating system when the USB stick 501 is place in communication with the computing device. In this embodiment, the executable file detects another executable file included in the first volume (i.e. the data partition,) and executes that file to further execute the business continuity management application.

Other embodiments include a USB device 501 that includes a bootstrap loader application 503. The bootstrap loader application 503 is the first application to execute once the USB device 501 establishes communication with a computing device. In one embodiment, the bootstrap loader uses a web service to download the required components for the sidebar application 509, to update the components included on the USB device 501. The bootstrap loader 503, in this embodiment, further passes execution to the sidebar loader application 509 once the USB device 501 is updated. In other embodiments, the bootstrap loader 503 can detect outdated versions of the BCM application, and further download and install newer components from the WFC server 194.

In one embodiment, the USB device 501 includes a sidebar loader application 506 and a sidebar application 509. The sidebar loader application 506, in this embodiment, provides the sidebar application 509 with settings, options and configuration files, which the sidebar application 509 uses to execute. Other embodiments include a sidebar application 509 that includes a sidebar loader application 506. Still other embodiments include a bootstrap loader 503 that includes a sidebar loader 506. The sidebar application 509, in one embodiment, executes on the USB device 501 and further displays a graphical display of a sidebar on the display screen of a computing machine. In this embodiment, the computing machine is the computing machine that is in communication with the USB device 501. Included within the sidebar application 509 are any of the following applications or services: status alerts; links to the portal; application delivery system; instant messenger; a soft-phone; roll call report; BWC system 160 client; forced contact information entry; remote desktop; message board; announcement board; or any other pre-defined application component or service. Other embodiments include either a sidebar loader 506, or a sidebar application 509 with a sidebar loader 506, where the loader application 506 communicates with the WFC server 194 to download all other program information useful to enable the USB device 501 to execute the business continuity management application.

Referring now to FIG. 3B, an embodiment of a method for setting up and provisioning a business workforce continuity system 160 USB device 501 is depicted. An administrator may create one or more users via an LDAP directory service, import the users and create one or more groups. The users may be grouped logically by functional area, department, geography, emergency response team, etc. A USB stick 501 is provided to the users, and an email is sent to each of the users providing information and instructions with regards to provisioning. The user receives an email with an installation URL. Once the user receives this email and clicks on the installation URL, installation of an online remote desktop control and collaboration agent, such as GoToMyPC from Citrix Online is initiated, and a user is created in the GoToMyPC system. A workforce continuity client is then downloaded and installed on the USB stick 501. In one embodiment, the workforce continuity client is downloaded or provided by the workforce continuity gateway or workforce continuity server. The installation processes installs a shortcut to GoToMyPC onto the stick. Upon completion of the installation, the USB stick 501 has been setup for the user to use with the BWC system 160 server or appliance in case of emergency.

Illustrated in FIG. 3C is an embodiment of a method 521 for deploying the BWC system 160 using the USB device 501. The method 501 includes receiving feedback data that indicates the USB device 501 was placed in communication with a computing device (step 523). A connection between the computing device and the BWC system is authenticated (step 526), and a remote access application is launched (step 529). A connection is then established between the client and the user's host computer (step 538).

Further referring to FIG. 3C and in more detail, in one embodiment, communication between the USB device 501 and a computing device is established when a user plugs the USB device 501 into the computing device (step 523). Other embodiments may not establish a connection until after a password is entered, or until after a secure connection is established between the USB device 501 and an business workforce continuity application executing on the computing machine.

The connection with the business workforce continuity servers, and in some cases business workforce continuity service, is authenticated (step 526). In one embodiment, authentication is done using LDAP.

In some embodiments, the user launches a remote access application (step 529). Embodiments include a remote access application that is GoToMyPC, or any other remote access application able to implement the methods and systems described herein. In this embodiment, the user is not required to provide any password or access code. Other embodiments include a client computing device that prompts the user for an access code or password. Still other applications may include a remote access application that is any other type or form of remote desktop control application, program or service, or any type and form or online collaboration tool.

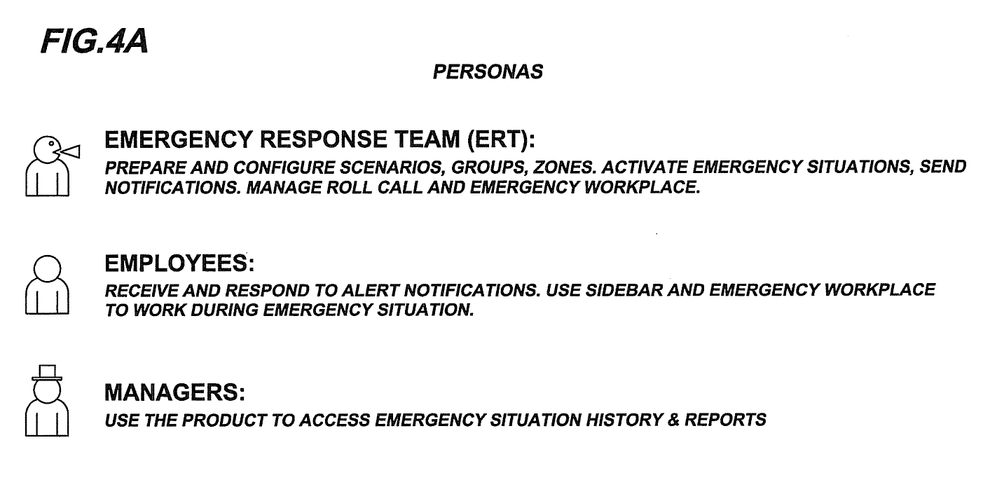

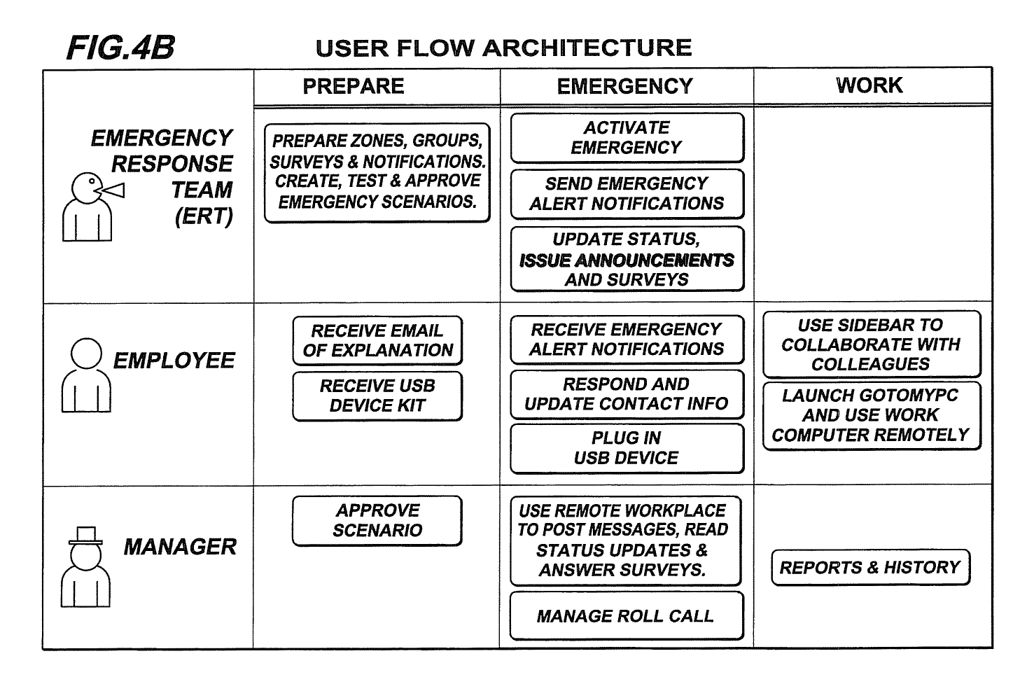

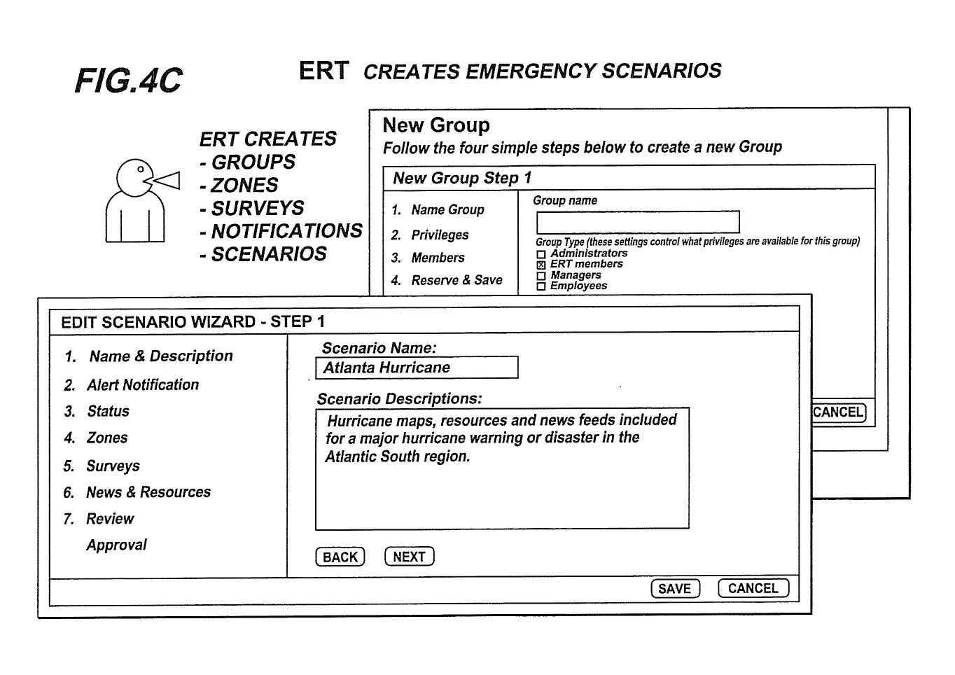

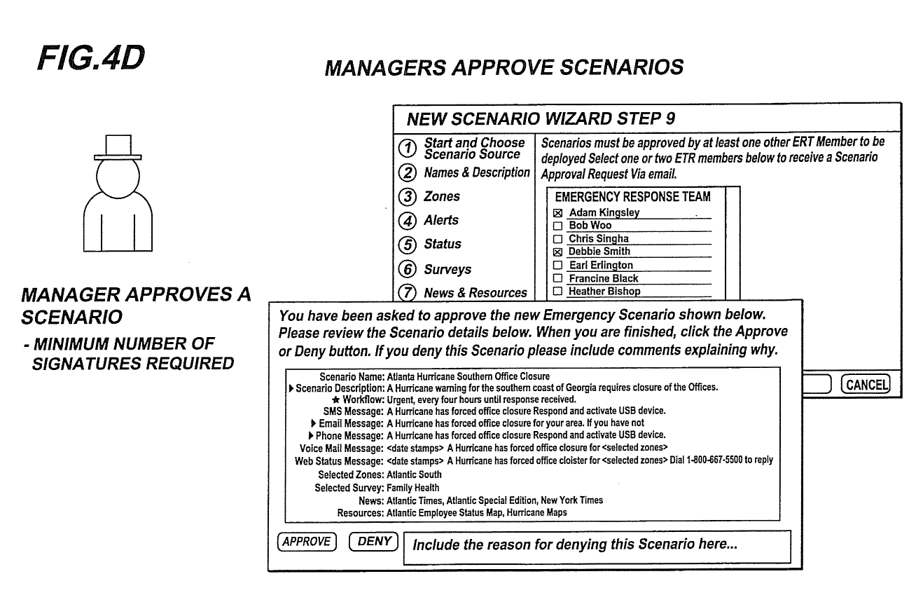

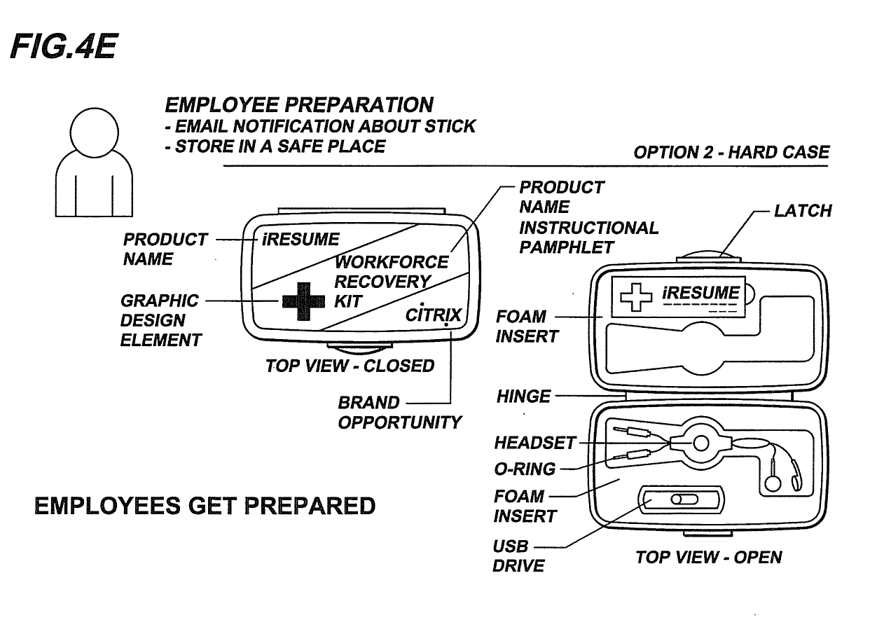

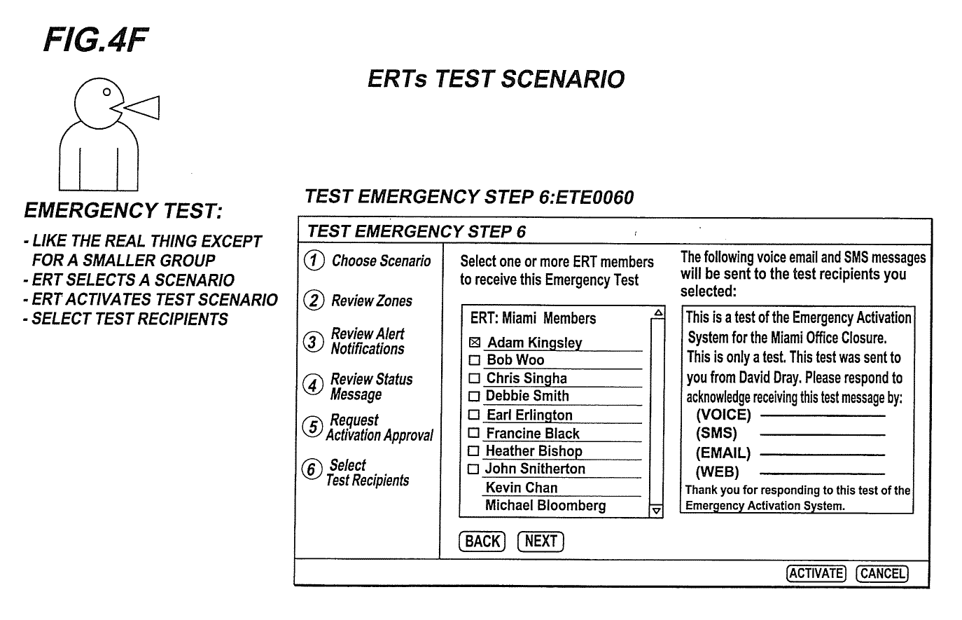

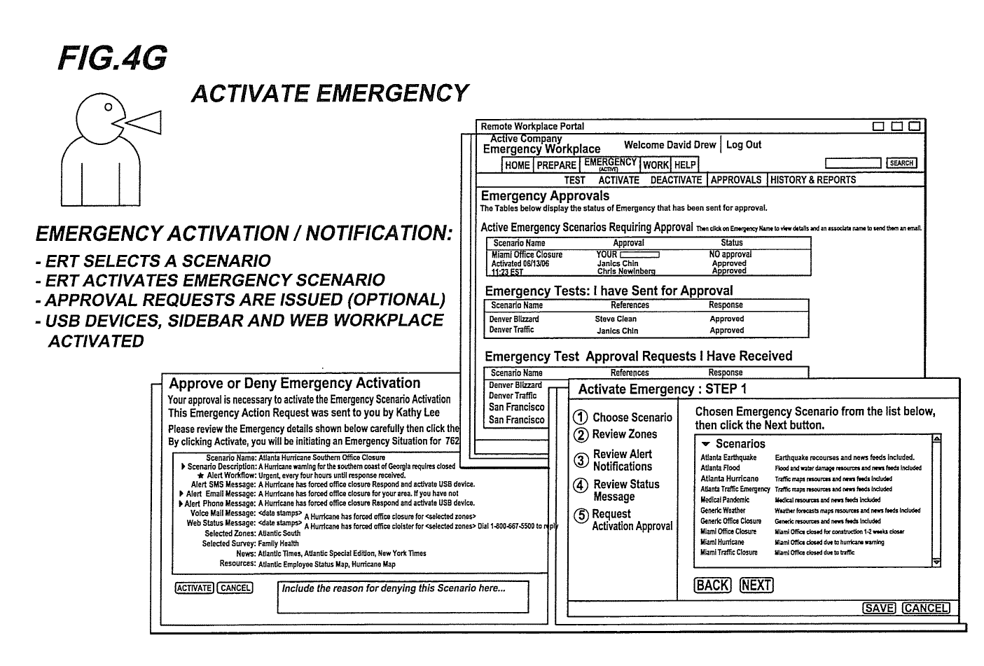

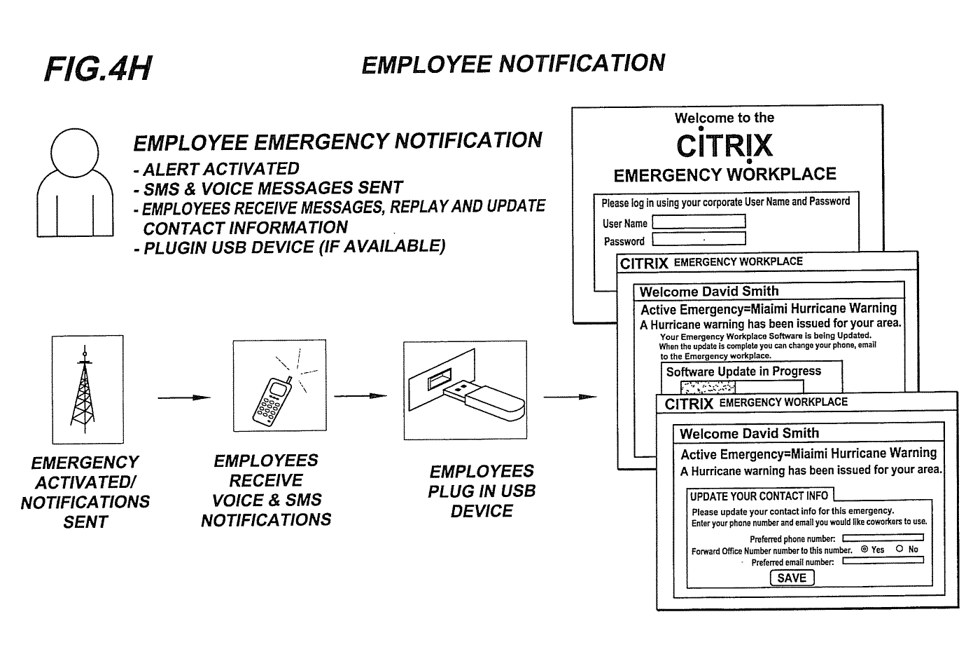

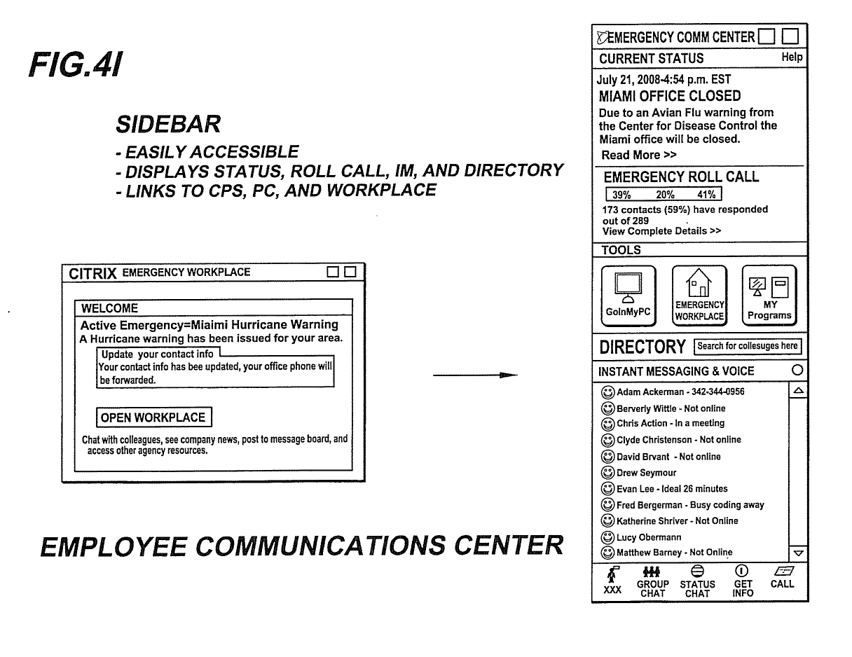

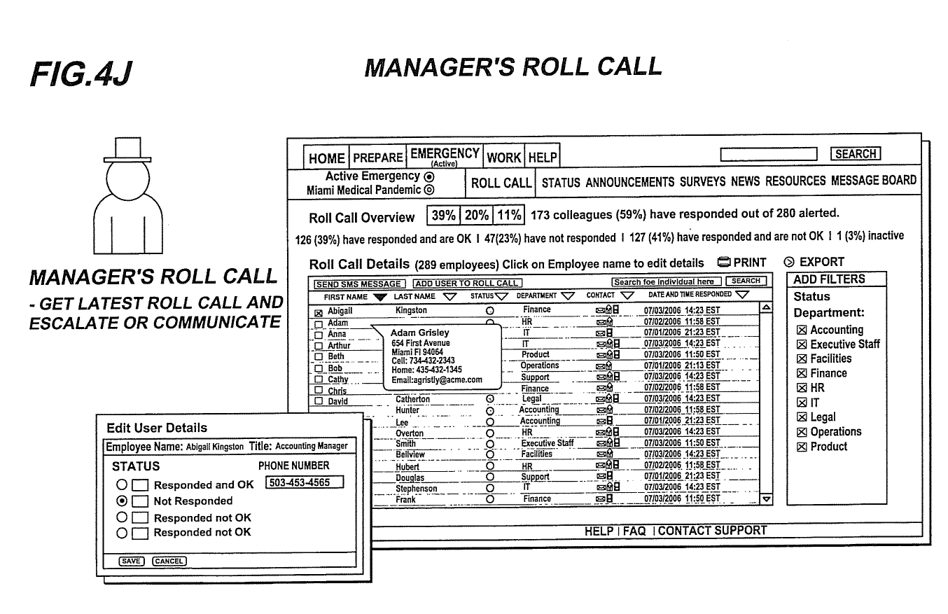

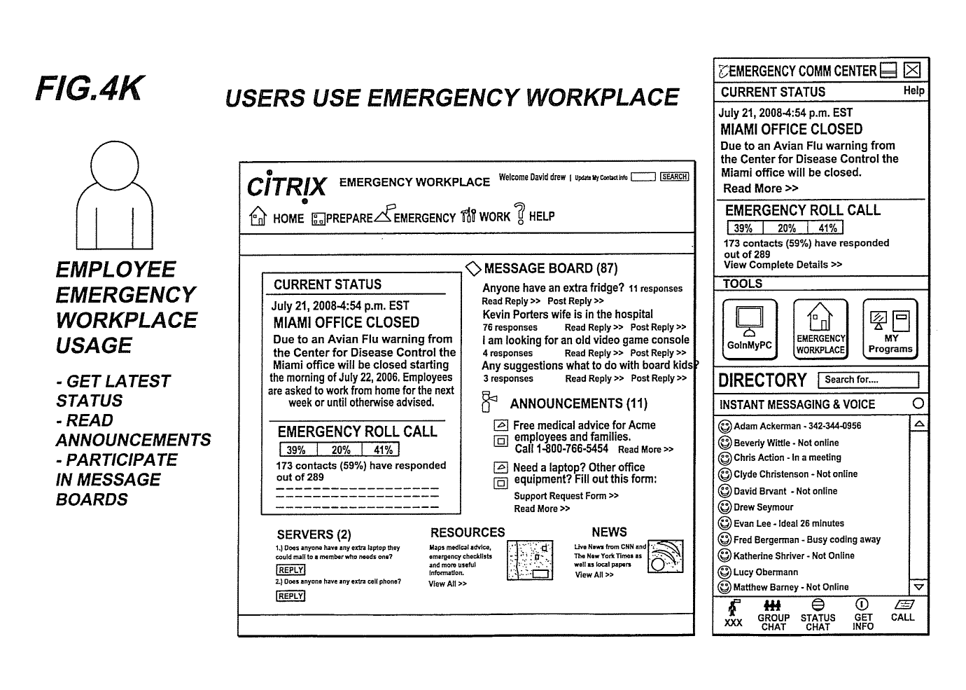

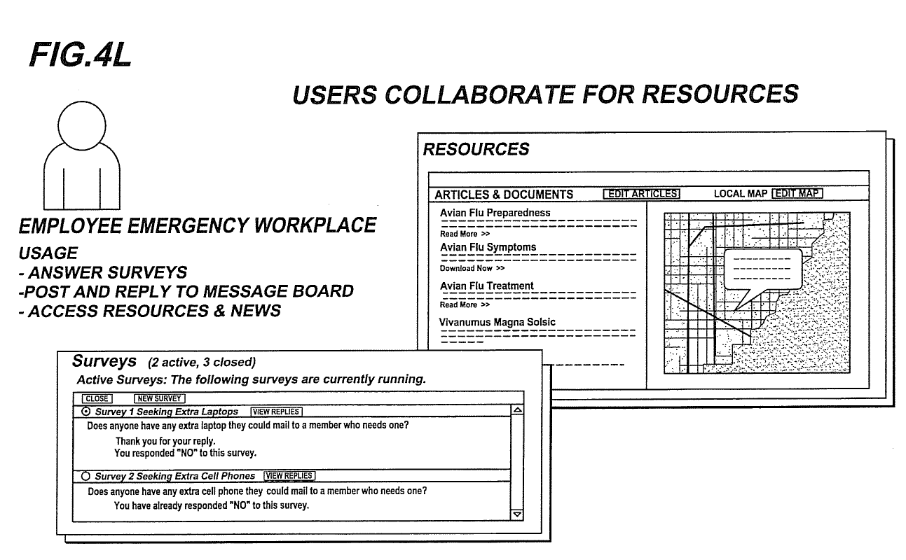

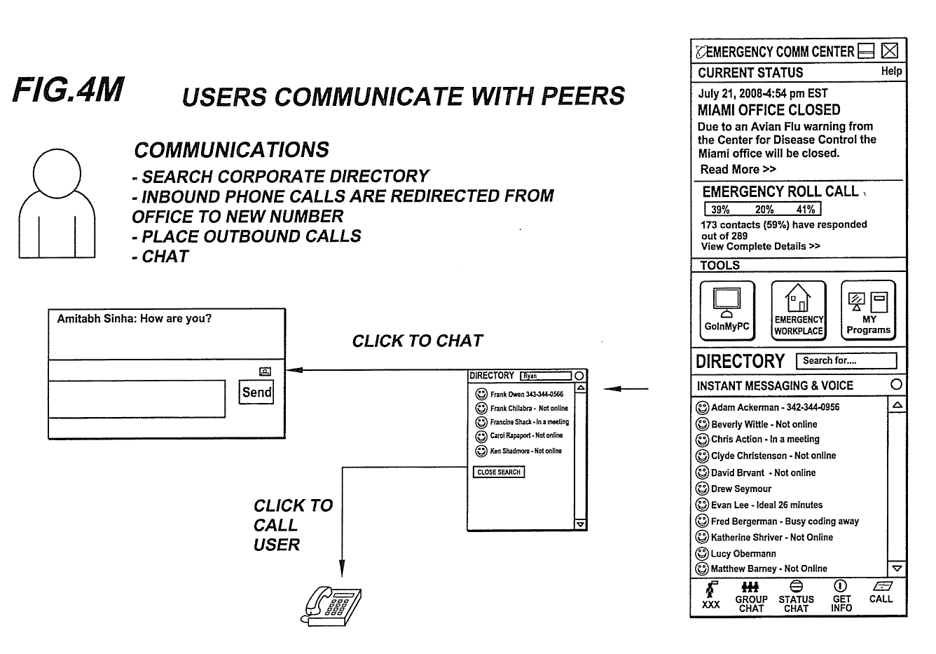

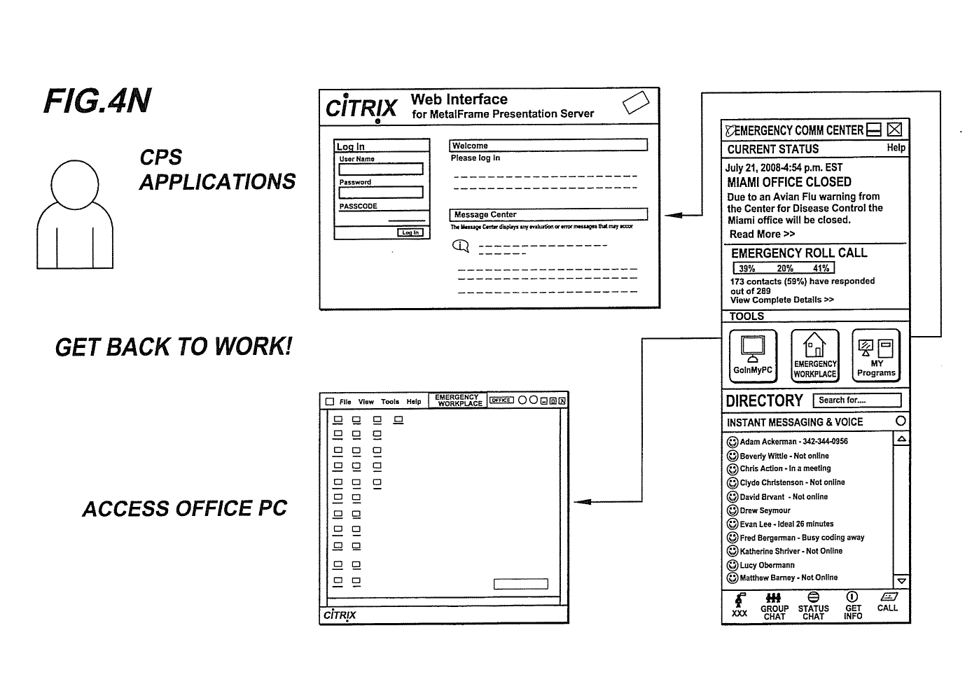

Referring now to FIGS. 4A-4N, embodiments of a web based user interface or portal provided by the BCM (WFC) server or via the BCM solution deployed as a SaaS model are depicted. The BCM provides a single point of contact for the setup, registration, and access of business and workforce continuity services, such as in the case of a disaster or emergency.

The BCM solution generally follows a three-step paradigm, methodology or scenarios of 1) prepare, 2) emergency, and 3) work. Under a preparation scenario, the BCM solution provides user interfaces and functionality to plan emergency scenarios, perform emergency drills or test, and to provision USB keys or devices. The preparation user interfaces and functionality described herein allow an emergency response team to prepare and configure emergency scenarios and configure the system for execution or deployment under a real emergency or disruptive event. When an emergency or disruptive event occurs, the BCM system provides user interfaces and functionality to deliver alerts and notifications to the user community, management and emergency response team as well as providing a roll and employee directory mechanism to account for, and obtain status and other information from geographically displaced team members. The emergency functionality of the BCM system allows for seamless ad-hoc collaboration among a displaced workforce. As displaced team member come online via the BCM solution, the next phase is the work phase. The BCM solution with client-side access provided via a USB stick allows displaced workers to obtain access to applications and data via any remote computing device. A displaced worker may be able to obtain access to his or hers corporate computer via GoToMyPC or to a remote desktop computing environment via Citrix Presentation Server. Additionally, a displaced work can communicate via softphone, instant messaging. SMS and the like via the Voice infrastructure of the BCM solution to facilitate work and emergency related activities.

The components of the BCM continuity system or service comprises: 1) keys, 2) servers and 3) services. The BCM solution provides users access and communication tools and capabilities via a provisioned USB device, stick or key. The server component of the BCM solution provides alerts and notification services, communication services, such as those provided by Live Communication Server, and secure access services such as via a VPN or SSL VPN gateway. The BCM solution also integrates with and provides access to remote desktop control and access services, such as GoToMyPC, as well as SMS and VoIP delivery of communications.

With the web-portal and user interfaces depicted in FIGS. 4A-4N, the BCM solutions provides scenario planning tools for Emergency Response Team personnel, as well as run-time collaboration and communication tools. The BCM servers and appliances provide an emergency communication and tracking solution for organizations. The BCM USB stick provides a simple and secure “work from anywhere” type solution for employees, such as employees displaced by an emergency or disruptive event.

Referring now to FIG. 4A, the BCM user interface or web portal is designed and constructed generally with three types of personas: 1) emergency response team (ERT), 2) employees and 3) managers. The ERT prepare and configure scenarios, groups and zones as will be illustrated in further detail below. The employees receive and response to alert notifications and use a client-side sidebar and/or emergency workplace portion of the portal to work during the Emergency situation. Managers use the portal and user interfaces described herein to access history and reports, such as a roll call, in managing the workforce during an emergency or disruptive situation. Although generally described from the perspective of these three personas, the BCM user interfaces or web portals may be designed and constructed for other types of users.

FIG. 4B depicts an embodiment of a user flow architecture in accessing or using the functionality provided by the BCM user interface or web portal. During the prepare phase, the ERT prepare zones, groups, surveys and notifications, and create, test and approve emergency scenarios. The employee may receive email with explanation on how to provision the USB device kit he or she received. Managers approve prepared or configured emergency scenarios.

During the emergency portion of the user flow, the ERT activate an emergency, send emergency alert notifications, and update status, issue announcements and surveys. Employees receive emergency alert notifications, respond and update contact information, and plug in USB device. A manager may use the remote workplace portion of the portal or BCM web-site to post messages, read status updates and answer surveys. Also, the manager may review, update or otherwise manage the roll call portion of the web-site.

During the work portion of the user flow, employees use the sidebar deployed via the plugged in USB device to collaborate with other employees via the BCM system. In some embodiments, the employee launches GoToMyPC to use work computer remotely. The manager reviews and works with reports and history information provided by the BCM solution.

FIG. 4C depicts an embodiment of user interfaces for an ERT team member to create emergency scenarios. Via these user interfaces, ERT personnel created groups, zones, surveys, notifications, and scenarios. In one embodiment, a user interface is a graphical display shown to an end-user when the end-user access the BCM application. A group can, in one embodiment, refer to a grouping of workforce members. In this embodiment, the grouping of workforce members is done using member identification information; while in other embodiments, the grouping is done based on other user-characteristic data. Groups can be used by an ERT team member to send notifications or messages out to a group of workforce members as opposed to sending an individual notification to each workforce member. Zones are used by ERT, in one embodiment, to define geographical zones, and to further used the zone information to facilitate and enable communication between the ERT team members or managers, and more than one workforce member. Surveys and notifications are, in some embodiments, forms of communication between the ERT personnel and those workforce members that are not ERT personnel. In one embodiment scenarios are emergency-defined scenarios that dictate operation of the BCM application and WFC system 160 when certain pre-defined emergencies are detected by the WFC system 160.

FIG. 4D depicts an embodiment of user interfaces for a manager to approve a prepared scenario. In some embodiments, a scenario may be configured to require a predetermined or minimum number of signatures (e.g., electronic approval) before the scenario is approved.

FIG. 4E depicts an embodiment of a BCM USB device kit provided to employees or users who will access the BCM services under an emergency or disruptive solution. The kit may comprise any type and form of case designed and constructed to hold the desired contents thereof. In some embodiments, the kit includes a USB drive or stick having content as described in conjunction with FIGS. 3A-3C, any type and form of headset for telecommunications, and an instructional pamphlet. In some embodiments, employees would maintain the USB kit in a manner appropriate to have access during a workplace disruption or emergency situation.

FIG. 4F depicts an embodiment of a user interface for an ERT to test a configured emergency scenario. In some embodiment, testing the emergency scenario is similar to a real emergency except for a smaller group of people. An ERT selects a scenario from a list of one or more configured scenarios, activates the test scenario and selected one or more recipients to participate in the test.

FIG. 4G depicts embodiments of user interfaces for an ERT to activate an emergency. As shown in FIG. 4G, an ERT selects a scenario from a list of one or more scenarios, and activate s the emergency scenario. In some embodiments, approval requests are issued if the activation of the scenario required approval. For example, approval requests may be, in one embodiment, the emergency scenario does not complete activation until a minimum set of approvals are obtained. In others embodiments, approval requests are issued but are optional to activate the emergency. Upon activation or completion thereof, USB devices, sidebar and workplace functionality are activated.

FIG. 4H depicts embodiments of user interfaces for providing employee emergency notification. The alert is activated and notifications are sent. Employees receive voice and SMS notifications, reply and update contact information. If available, the employees plug in their USB devices.

FIG. 4I depicts an embodiment of a client-side sidebar which provides an emergency communication center that works in conjunction with and communicates to the BCM system. In some embodiments, the sidebar application is provided on or via the USB device. In other embodiments, the employee or user downloads the sidebar application from the BCM web-site or the WFC gateway or server to the user's computing device. The employee communications center provided by the sidebar application or agent displays status information, roll call, instant messaging and directory information. The employee communication centers provide links or access to Citrix Presentation server, remote control of a desktop of the user and access to the workplace functional area and user interface of the BCM portion as described herein.

FIG. 4J depicts an embodiment of user interface for providing a roll call management and information screen for the manager role in the BCM system. The manager can get the latest roll call information and escalate a status of an employee or communicate or try to communicate with employees. The manager can create, modify or update a status of information in the roll call.

FIG. 4K depicts an embodiment of the emergency workplace portion of the BCM web portal. In one embodiment, a user can access the emergency workplace from the sidebar or employee communications center. In the employee emergency workplace user interface, an employee reviews the current status of the emergency or disruptive information (for example, as it is updated by ERT personnel). The employee reviews announcements and participate (post and reply) in message boards. The user interface also displays information for the employee regarding the employee roll call, with links to surveys, resources and news. The employee can take surveys to provide information and status to the BCM system for updating reports and for tracking people and resources.

FIG. 4L depicts an embodiment of a user interface for user to collaborate with regards to resources. In the employee emergency workplace of the web-portal, the user answers surveys and reviews replies to surveys. In one embodiment, the resources area of the workplace provides a graphical display of a map that identifies locations and types of resources. In some embodiments, the map is an interface and a user may add, edit or place/relocate resources on the map. In other embodiments, the map identifies geographical impacts and other status information related to the emergency or disruptive event.

FIG. 4M is an embodiment of user interfaces for users to communicate with peers. Via the emergency communication center, users can search the corporate directory for contact information, including updated or emergency contact information. Via the BCM system and the emergency communication centers, inbound calls are re-directed from the office extension (e.g., PBX extension) to a new number, such as a soft-phone on the user's computing device or included in the sidebar. In some embodiments, inbound calls are redirected to the user of the communication center via any of the redirection embodiments discussed above in conjunction with FIGS. 2A-2D. Via the emergency communication center, the user can place outbound calls. In some embodiments, the outbound calls may be forwarded, transferred or redirected via any of the embodiments discussed above in conjunction with FIGS. 2A-2D. In yet another embodiment, the emergency communication centers enables user to chat or instant message their peers.

FIG. 4N depicts an embodiment of a user interface to access the user's application and data. In some embodiments, the user launches a user interface from the emergency communications center to access applications and data via an application delivery system, such as Citrix Presentation server. For example, the user clicks on the “my programs” user interface element as depicted in FIG. 4M. In other embodiments, the user launches a user interface to access a remote desktop, such as a corporate or office computer, via GoToMyPC services. For example, the user clicks the GoToMyPC user interface element as depicted in FIG. 4N.

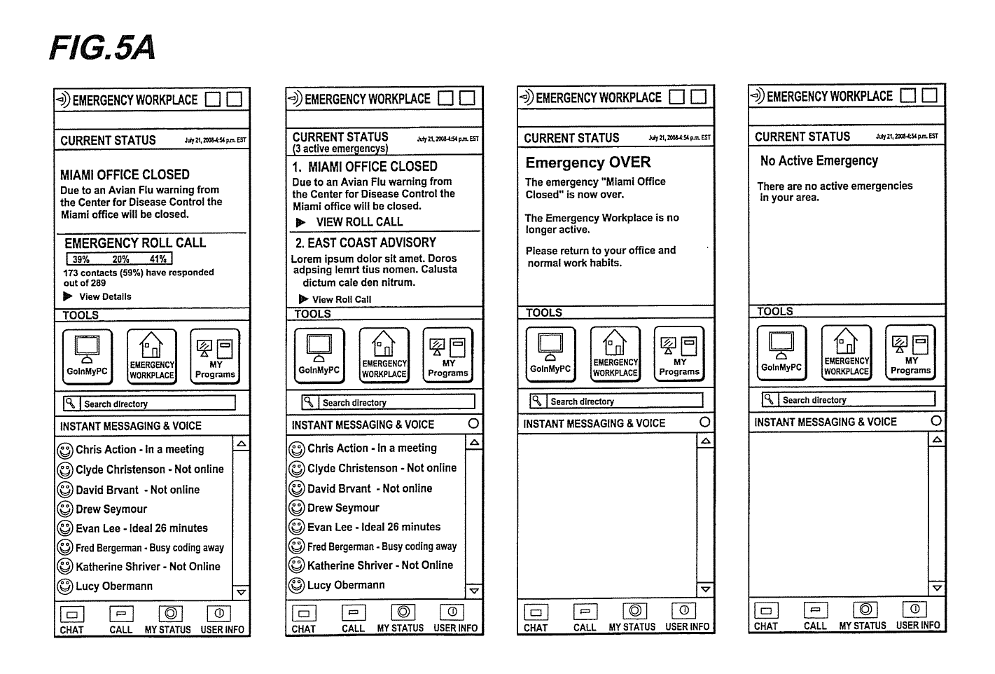

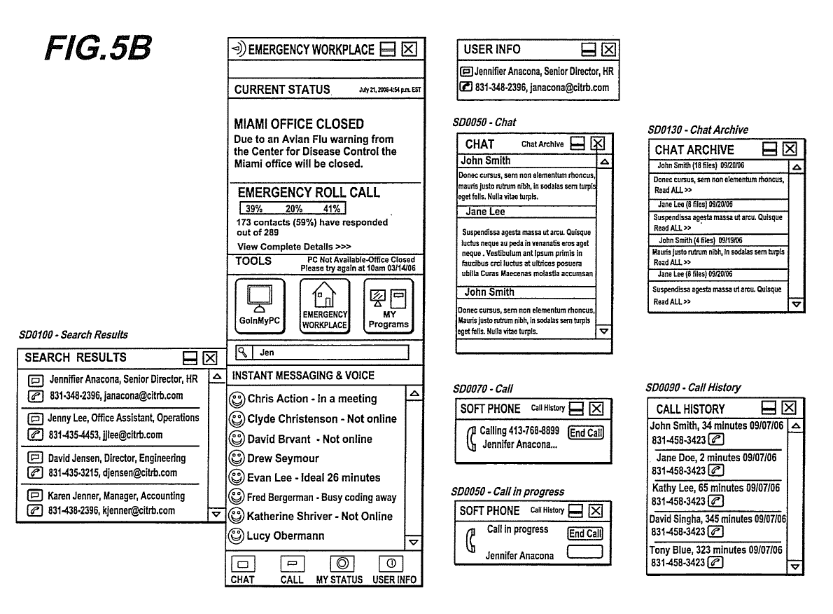

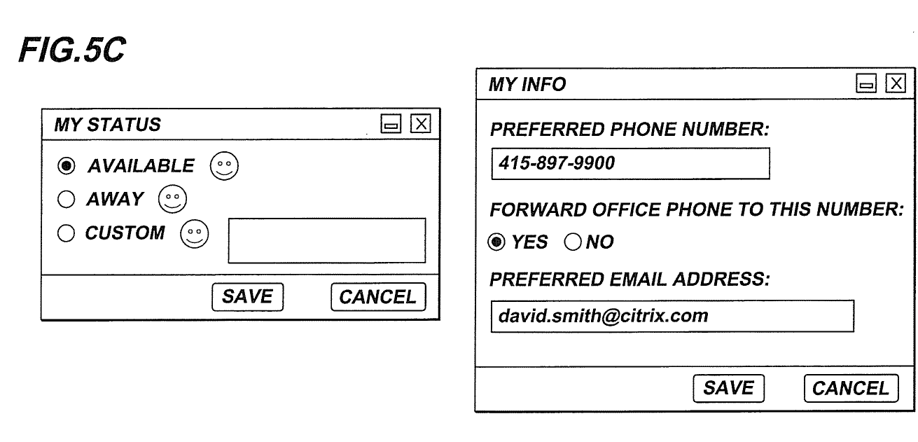

FIGS. 5A-5C each depict an embodiment of a plurality of user interfaces for the sidebar or WFC client. The sidebar user interfaces of the emergency communication center may display one or more of the following: 1) one emergency active, 2) multiple emergencies active, 3) emergency over, 4) no active emergency, 5) search results, 6) the logged in user's status and info and contact information 7) peer information, 8) chat session, 9) chat archive, 10) soft-phone calling, 11) soft-phone call in progress status, and 12) call history.

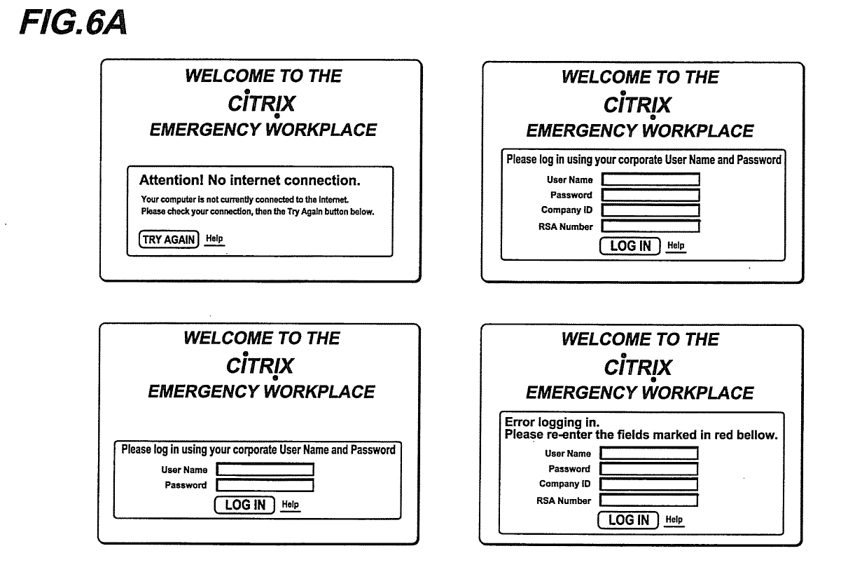

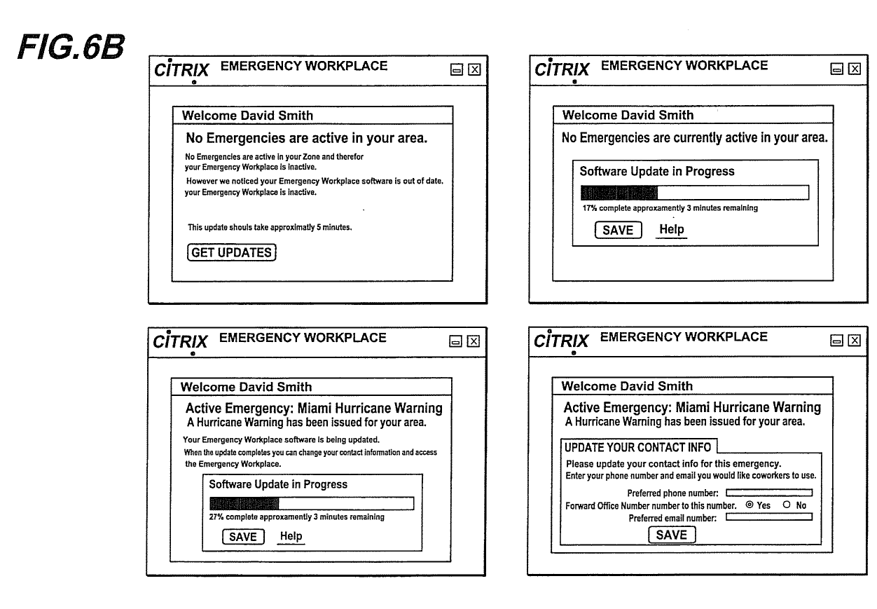

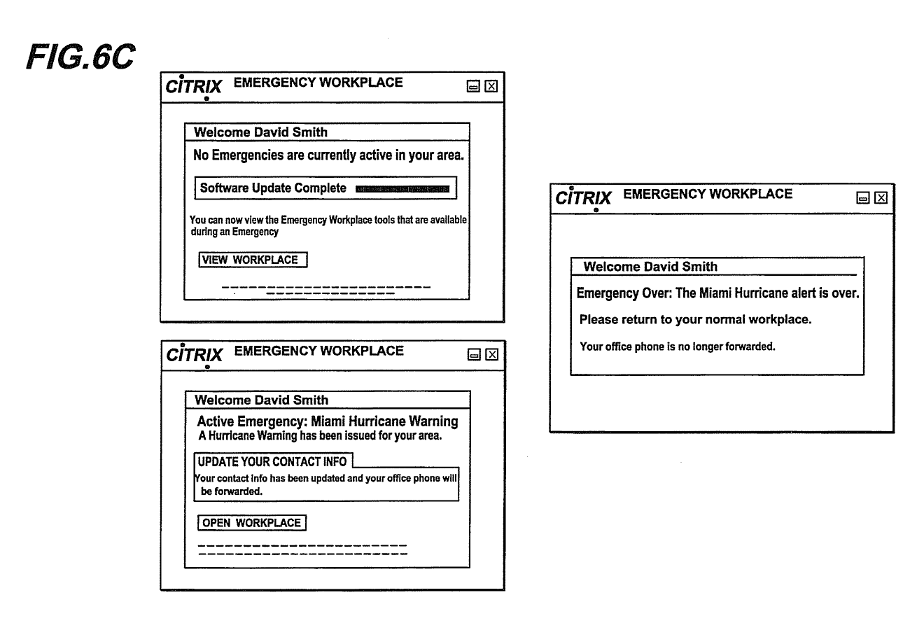

FIGS. 6A-6C depicts embodiments of a plurality of user interfaces for startup screens when a user deploys and uses the BCM USB stick to access BCM servers or services, such as in the case of an emergency or disruptive event. The startup user screens may display one or more of the following types of screens: 1) no internet connection, 2) a login and password screen, 3) error logging in message, 4) welcome, no emergencies in progress, 5) welcome, active emergencies in progress, updating software, 6) welcome, no emergency in progress, update in progress, 7) welcome, active emergencies in progress, update contact information, 8) welcome, active emergencies in progress, update complete, 9) welcome, one or more emergencies in progress, and 10) welcome, emergency over.

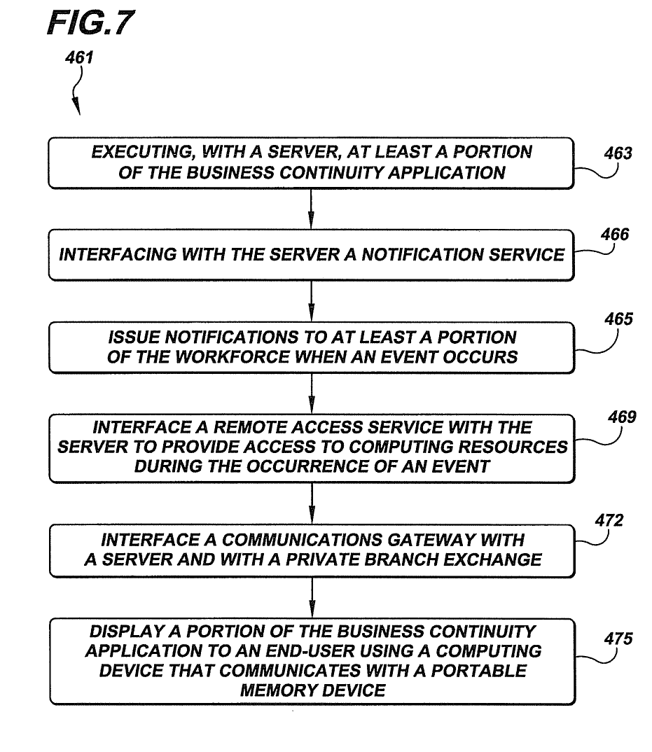

Illustrated in FIG. 7 is a method 461 for providing a business workforce continuity system that further provides a displaced workforce with business continuity. A server executes at least a portion of the business continuity application (step 463). The server interfaces with a notification service (step 466), and issues notifications to at least a portion of the workforce when an event occurs (step 465). A remote access service also interfaces with the server to provide access to computing resources during the occurrence of an event (step 469). The server also interfaces with a communications gateway which is further interfaced with a private branch exchange (step 472). A portion of the business continuity application, after the occurrence of an event, is displayed to an end-user using a computing device that further communicates with a portable memory device (step 475).

Referring to FIG. 7 in more detail, in one embodiment of the method 461, a server executes at least a portion of the business continuity application (step 463). In one embodiment, the business continuity application is the business workforce continuity system 160. Other embodiments include a business continuity application that is displayed to a displaced workforce of an organization, when an event occurs. The server, can in one embodiment, be a computing device like the above described computing device 100. In this embodiment, the server can be a computing device at a data center. Other embodiments include a server that stands alone, or a client machine or third computing device able to execute at least a portion of the business continuity application. In one embodiment the business continuity application includes an application for defining a response scenario to the occurrence of the event.

In one embodiment, the method 461 further includes interfacing a notification service to the server computing device (step 466). The notification service can be any of the systems illustrated in the above figures, including those that depict a method for re-directing phone calls to emergency phone numbers or to other emergency points of contact. Within these embodiments, the notification service can be further used to issue notifications to at least a portion of the workforce in response to the occurrence of an event (step 465).

A remote access service also interfaces with the server or data center to provide the workforce members with access to computing resources during the emergency event (step 469). In one embodiment, the remote access service can be any of the above described remote access services such as any of the following: thin-client computing applications; remote display presentation application; Citrix Access Suite; Metaframe or Citrix Presentation Server; terminal services; any type of hosted server application like GoToMeeting, Webex, or Live Meeting; or any other type of application that provides workforce members with remote access to computing resources associated with the workforce. In one embodiment, the computing resources can include applications, files, and file directories located within the workforce computing environment. The remote access service is available, in some embodiments, when there is no emergency event. Other embodiments include a remote access service that is available only during emergency events.

In one embodiment, a communication gateway interfaces with both the private branch exchange and the server (step 472). In this embodiment the communication gateway can be any of the above described gateways including: a workforce continuity gateway 192; a media gateway 198; a VoIP gateway; or any other appliance, computing machine or other device that provides an interface between the private branch exchange and the server. Other embodiments include a communications gateway that further provides a portion of the BWC system application.

A graphical display is shown to an end-user using a computing machine that accesses the BWC system 160, where the computing device is in communication with a portable memory device (step 475). In one embodiment, a portion of the business continuity management application is displayed to the end-user. Portions of the business continuity management application can include any of the following elements of the BWC system 160 either alone or together in combinations of two or more elements: sidebar application; remote access capabilities; call re-direction; emergency activation; more than one emergency activation; emergency activation management; emergency activation approval; search results; peer-to-peer chat sessions amongst members of the workforce; chat sessions and chat archives; soft-phone; call history; workforce member status information; account management; user status information update; remote file access; virtual meeting access; emergency call logging; storage of emergency contact information; a directory service; audio communication application; remote or local access to business tools; or any other aspect of the BWC system 160 and BCM described herein. Other embodiments display the entirety of the business continuity management application. Embodiments include a computing device in communication with a portable memory device, where the portable memory device is the USB device 501. Other memory devices may be used including any of those memory devices described herein.

What is claimed is:

1. A method of providing a business continuity application to a portion of a displaced workforce of an organization in response to the occurrence of an event, the method comprising:
providing a server computing device at a data center, the server computing device executing at least a portion of a business continuity application, the business continuity application including an application for defining a response scenario to the occurrence of the event;
interfacing a notification service to the server computing device, the notification service issuing a notification to at least a portion of the workforce in response to the occurrence of the event;
interfacing a remote access service to the server computing device, the remote access service providing access to computing resources associated with the workforce during the occurrence of the event;
interfacing a communications gateway to a private branch exchange of the workforce and to the server computing device, the communications gateway providing at least another portion of the business continuity application; and
displaying, to an end-user of a computing device having a portable memory device in communication therewith, portions of the business continuity application after the occurrence of the event.

2. The method of claim 1, further comprising providing a business continuity application via application streaming.

3. The method of claim 1, further comprising providing a business continuity application via an remote display protocol.

4. The method of claim 1, wherein providing a business continuity application further comprises providing the business continuity application as a service.

5. The method of claim 1, wherein issuing a notification to at least a portion of the workforce further comprises:
placing a call to a number designated by a caller, to establish communication between a first endpoint and a second endpoint;
receiving feedback information indicative of the failure to establish communication between the first endpoint and the second endpoint;;
redirecting the call to a portion of the notification service;
retrieving, from a storage element, contact information associated with the caller designated number and indicative of a third endpoint; and
placing a call to the retrieved contact information, to establish communication between the first endpoint and the third endpoint.

6. The method of claim 5, wherein placing a call to a second endpoint further comprises placing a call to a member of the workforce.

7. The method of claim 6, wherein retrieving contact information further comprises retrieving an emergency number associated with the member of the workforce.

8. The method of claim 6, wherein retrieving contact information further comprises retrieving an email address associated with the member of the workforce.

9. The method of claim 5, wherein placing a call to the retrieved contact information further comprises placing a call to the retrieved contact information using one of either of the private branch exchange and a public switched telephone network.

10. The method of claim 5, wherein placing a call to the retrieved contact information further comprises placing a call to the retrieved contact information using a virtual private network.

11. The method of claim 1, wherein providing access to computing resources associated with the workforce further comprises providing access to information on a client machine using a remote display protocol.

12. The method of claim 1, wherein displaying portions of a business continuity application further comprises displaying a graphical user interface representative of a status of the occurrence of the event.

13. The method of claim 1, wherein displaying portions of a business continuity application further comprises displaying a graphical user interface representative of a directory service that accesses information of the workforce.

14. The method of claim 1, wherein displaying portions of a business continuity application further comprises displaying a graphical user interface for establishing and interacting with an audio communications session.

15. The method of claim 1, wherein displaying portions of a business continuity application further comprises displaying a graphical user interface for establishing and interacting with an instant messaging system.

16. The method of claim 1, wherein interfacing with a communications gateway further comprises interfacing with a workforce gateway within a workforce continuity system.

17. The method of claim 16, wherein interfacing with a workforce gateway further includes establishing a connection via a network installed between the computing machine and the private branch exchange.

18. A graphical user interface displayed on a computing device for use in providing continuity to an employee of workforce in response to the occurrence of an event, the graphical user interface created by a program stored on a portable memory device, the graphical user interface comprising:
a first portion displaying, by a first portion of the program stored on a portable device associated with an employee of the workforce, information related to the status of the occurrence of the event;
a second portion displaying a plurality of business tools available to the employee, each business tool being represented as icon and associated with a computing device providing the respective business tool;
a third portion providing a directory service to the employee, the directory service associated with directory information of the workforce; and
a fourth portion displaying a list of at least a portion of the employees of the work force and a status related each of the employees listed and a providing a mechanism for establishing at least one of an audio communications session and an instant messaging session.

19. The graphical user interface of claim 18, wherein the portable memory device is a universal serial bus device.

20. The graphical user interface of claim 19, wherein the universal serial bus device further comprises:
a first reported volume configured to store data, a portion of the data including the program stored on the universal serial bus; and
a second volume configured to store a bootstrap loader application, the bootstrap loader application further configured to update and execute the stored program.

21. The graphical user interface of claim 18, wherein business tools include a remote access application providing remote access to a server in communication with the computing device.

22. The graphical user interface of claim 18, wherein business tools include a remote access application providing remote access to a second computing device in communication with the computing device.

23. The graphical user interface of claim 18, wherein the directory service is further in communication with a storage element configured to store workforce member contact information.
